(19) United States
(12) Patent Application Publication
(10) Pub. No.: US 2014/0043713 A1
(43) Pub. Date: Feb. 13, 2014

(54) MAGNETO-RESISTANCE EFFECT ELEMENT, MAGNETIC HEAD, MAGNETIC HEAD ASSEMBLY, MAGNETIC RECORDING AND REPRODUCING APPARATUS, AND METHOD FOR MANUFACTURING MAGNETO-RESISTANCE EFFECT ELEMENT

(71) Applicant: KABUSHIKI KAISHA TOSHIBA, Tokyo (JP)

(72) Inventors: Yousuke ISOWAKI, Kanagawa-ken (JP); Hitoshi IWASAKI, Tokyo (JP); Masayuki TAKAGISHI, Tokyo (JP)

(21) Appl. No.: 13/936,652

(22) Filed: Jul. 8, 2013

(30) Foreign Application Priority Data
Aug. 13, 2012 (JP) 2012-179528

(51) Int. Cl. G11B 5/11; H01F 41/02; H01F 7/00

(52) U.S. Cl. CPC G11B 5/11; H01F 7/00; H01F 41/02
USPC 360/244; 360/319; 335/301; 29/602.1

(57) ABSTRACT

According to one embodiment, a magneto-resistance effect element includes a first shield, a second shield, a third shield, a first magnetic layer, a second magnetic layer, and an intermediate layer. The third shield is provided between the first shield and the second shield, and is in contact with the second shield. A length of the third shield along a first direction crossing a stacking direction from the first shield toward the second shield is shorter than a length along the first direction of the second shield. The first magnetic layer is provided between the first shield and the third shield. The second magnetic layer is provided between the first magnetic layer and the third shield, and is exchange-coupled to the third shield. The intermediate layer is provided between the first magnetic layer and the second magnetic layer.

### CROSS-REFERENCE TO RELATED APPLICATIONS

This application is based upon and claims the benefit of priority from the prior Japanese Patent Application No. 2012-179528, filed on Aug. 13, 2012; the entire contents of which are incorporated herein by reference.

### FIELD

Embodiments described herein relate generally to a magneto-resistance effect element, a magnetic head, a magnetic head assembly, a magnetic recording and reproducing apparatus, and a method for manufacturing the magneto-resistance effect element.

### BACKGROUND

For the signal reproduction of a HDD (hard disk drive), for example, a TMR head (tunneling magneto-resistive head) is used. A magneto-resistance effect element provided in the TMR head includes a magnetic stacked film and shields sandwiching the magnetic stacked film. To increase the recording density of the HDD, it is desired for the magneto-resistance effect element to be miniaturized.

### BRIEF DESCRIPTION OF THE DRAWINGS

FIG. 1A to FIG. 1D are schematic views showing a magneto-resistance effect element according to a first embodiment;

FIG. 2 is a schematic perspective view showing a magnetic head in which the magneto-resistance effect element according to the first embodiment is mounted;

FIG. 3 is a schematic perspective view showing a head slider in which the magneto-resistance effect element according to the first embodiment is mounted;

FIG. 4A to FIG. 4D are schematic views showing another magneto-resistance effect element according to the first embodiment;

FIG. 5A to FIG. 5E are schematic cross-sectional views in order of the processes, showing a method for manufacturing the magneto-resistance effect element according to the first embodiment;

FIG. 6A to FIG. 6D are graphs showing characteristics of the magneto-resistance effect element according to the first embodiment;

FIG. 7 is a graph showing characteristics of the magneto-resistance effect element according to the first embodiment;

FIG. 8A to FIG. 8D are schematic views showing other magneto-resistance effect elements according to the first embodiment;

FIG. 9A to FIG. 9D are schematic views showing other magneto-resistance effect elements according to the first embodiment;

FIG. 10A to FIG. 10D are schematic views showing other magneto-resistance effect elements according to the first embodiment;

FIG. 11A to FIG. 11D are schematic views showing other magneto-resistance effect elements according to the first embodiment;

FIG. 12A and FIG. 12B are schematic views showing a magneto-resistance effect element according to a second embodiment;

FIG. 13A and FIG. 13B are graphs showing characteristics of the magneto-resistance effect element according to the second embodiment;

FIG. 14A to FIG. 14D are schematic views showing other magneto-resistance effect elements according to the second embodiment;

FIG. 15A to FIG. 15D are schematic views showing other magneto-resistance effect elements according to the second embodiment;

FIG. 16 is a schematic perspective view showing a magnetic recording and reproducing apparatus according to a third embodiment; and

FIG. 17A and FIG. 17B are schematic perspective views showing part of a magnetic recording apparatus according to the third embodiment.

### DETAILED DESCRIPTION

According to one embodiment, a magneto-resistance effect element includes a first shield, a second shield, a third shield, a first magnetic layer, a second magnetic layer, and an intermediate layer. The third shield is provided between the first shield and the second shield, and is in contact with the second shield. A length of the third shield along a first direction crossing a stacking direction from the first shield toward the second shield is shorter than a length along the first direction of the second shield. The first magnetic layer is provided between the first shield and the third shield. The second magnetic layer is provided between the first magnetic layer and the third shield, and is exchange-coupled to the third shield. The intermediate layer is provided between the first magnetic layer and the second magnetic layer.

According to one embodiment, a magneto-resistance effect element includes a first shield, a second shield, a nonmagnetic layer, a first magnetic layer, a third shield, a second magnetic layer, a first electrode unit, and an insulating layer. The nonmagnetic layer is provided between the first shield and the second shield. The first magnetic layer is provided between the nonmagnetic layer and the second shield. The third shield is provided between the first magnetic layer and the second shield. The third shied is in contact with the second shield, and has a length along a first direction crossing a stacking direction from the first shield toward the second shield shorter than a length along the first direction of the second shield. The second magnetic layer is provided between the nonmagnetic layer and the second shield and is apart from the first magnetic layer in a second direction crossing the stacking direction and the first direction. The first electrode unit is provided between the second magnetic layer and the second shield. The insulating layer is provided between the first electrode unit and the second shield.

According to one embodiment, a magnetic head includes a magneto-resistance effect element. The magneto-resistance effect element includes a first shield, a second shield, a third shield, a first magnetic layer, a second magnetic layer, and an intermediate layer. The third shield is provided between the first shield and the second shield, and is in contact with the second shield. A length of the third shield along a first direction crossing a stacking direction from the first shield toward the second shield is shorter than a length along the first direction of the second shield. The first magnetic layer is provided between the first shield and the third shield. The second magnetic layer is provided between the first magnetic layer and the third shield, and is exchange-coupled to the third shield. The intermediate layer is provided between the first magnetic layer and the second magnetic layer.

According to one embodiment, a magnetic head assembly includes a magnetic head, a suspension mounted with the magnetic head at one end, and an actuator arm connected to another end of the suspension. The magnetic head includes a magneto-resistance effect element. The magneto-resistance effect element includes a first shield, a second shield, a third shield, a first magnetic layer, a second magnetic layer, and an intermediate layer. The third shield is provided between the first shield and the second shield, and is in contact with the second shield. A length of the third shield along a first direction crossing a stacking direction from the first shield toward the second shield is shorter than a length along the first direction of the second shield. The first magnetic layer is provided between the first shield and the third shield. The second magnetic layer is provided between the first magnetic layer and the third shield, and is exchange-coupled to the third shield. The intermediate layer is provided between the first magnetic layer and the second magnetic layer.

According to one embodiment, a magnetic recording and reproducing apparatus includes a magnetic head assembly; and a magnetic recording medium. The magnetic head assembly includes a magnetic head, a suspension mounted with the magnetic head at one end, and an actuator arm connected to another end of the suspension. The magnetic head includes a magneto-resistance effect element. The magneto-resistance effect element includes a first shield, a second shield, a third shield, a first magnetic layer, a second magnetic layer, and an intermediate layer. The third shield is provided between the first shield and the second shield, and is in contact with the second shield. A length of the third shield along a first direction crossing a stacking direction from the first shield toward the second shield is shorter than a length along the first direction of the second shield. The first magnetic layer is provided between the first shield and the third shield. The second magnetic layer is provided between the first magnetic layer and the third shield, and is exchange-coupled to the third shield. The intermediate layer is provided between the first magnetic layer and the second magnetic layer. Information is reproduced from the magnetic recording medium using the magnetic head mounted on the magnetic head assembly.

According to one embodiment, a method for manufacturing a magneto-resistance effect element includes stacking including forming a first magnetic film on a first shield, forming an intermediate film on the first magnetic film, forming a second magnetic film on the intermediate film, and forming a first shield film on the second magnetic film. The method further includes patterning including patterning the first magnetic film, the intermediate film, the second magnetic film, and the first shield film to form a first magnetic layer, an intermediate layer, a second magnetic layer, and a second shield. The method further includes forming a third shield directly on the second shield, the third shield having a length in a first direction crossing a stacking direction from the first shield toward the second shield longer than a length in the first direction of the second shield.

Various embodiments will be described hereinafter with reference to the accompanying drawings.

The drawings are schematic or conceptual; and the relationships between the thickness and width of portions, the proportions of sizes among portions, etc. are not necessarily the same as the actual values thereof. Further, the dimensions and proportions may be illustrated differently among drawings, even for identical portions.

In the specification of this application and the drawings, components similar to those described in regard to a drawing thereinabove are marked with the same reference numerals, and a detailed description is omitted as appropriate.

### FIRST EMBODIMENT

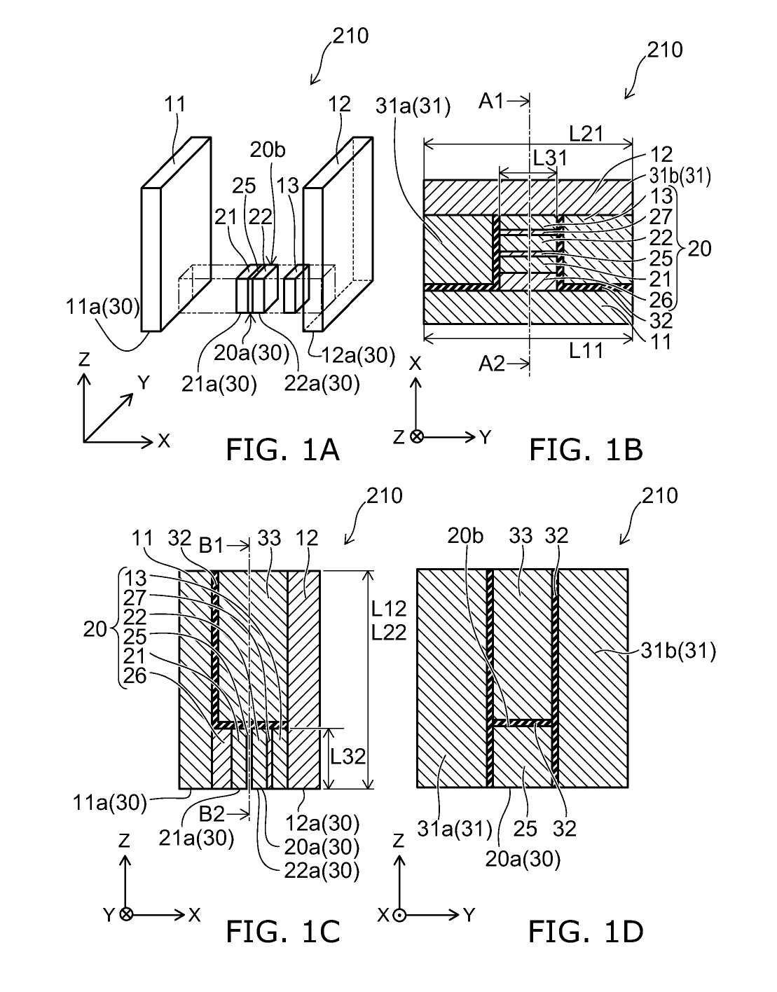

FIG. 1A to FIG. 1D are schematic views illustrating the configuration of a magneto-resistance effect element according to a first embodiment.

FIG. 1A is a disassembled perspective view. FIG. 1B is a plan view. FIG. 1C is a cross-sectional view taken along line A1-A2 of FIG. 1B. FIG. 1D is a cross-sectional view taken along line B1-B2 of FIG. 1C. In FIG. 1A, the illustration of some layers is omitted for easier viewing of the drawing.

As shown in FIG. 1A to FIG. 1D, a magneto-resistance effect element 210 according to the embodiment includes a first shield 11, a second shield 12, a third shield 13, a first magnetic layer 21, a second magnetic layer 22, and an intermediate layer 25.

The third shield 13 is provided between the first shield 11 and the second shield 12. The third shield 13 is in contact with the second shield 12.

The direction from the first shield 11 toward the second shield 12 (stacking direction) is defined as an X-axis direction. One direction perpendicular to the X-axis direction is defined as a Y-axis direction. The direction perpendicular to the X-axis direction and the Y-axis direction is defined as a Z-axis direction.

A direction crossing the stacking direction from the first shield 11 toward the second shield 12 (the X-axis direction) is defined as a first direction. In the following, a description is given using the case where the first direction is orthogonal to the stacking direction. It is assumed that the first direction is the Y-axis direction.

The length (length L31) along the first direction (in this example, the Y-axis direction) of the third shield 13 is shorter than the length (length L21) along the first direction of the second shield 12.

In this example, the length L31 along the first direction of the third shield 13 is shorter than the length (length L11) along the first direction of the first shield 11.

The length L21 along the first direction of the second shield 12 is the length along the first direction of the second shield 12 in the portion opposed to the third shield 13 of the second shield 12.

The length L11 along the first direction of the first shield 11 is the length along the first direction of the first shield 11 in the portion opposed to the third shield 13 of the first shield 11.

In the case where the length along the first direction of the third shield 13 changes along, for example, the Z-axis direction, it is assumed that the length L31 is the length along the first direction of the third shield 13 at the center in the Z-axis direction of the third shield 13.

In this example, the length L32 of the third shield 13 along a direction crossing the stacking direction (the X-axis direction) and the first direction (in this example, the Y-axis direction) is shorter than the length L22 along the crossing direction of the second shield 12. In this example, it is assumed that the direction crossing the stacking direction (the X-axis direction) and the first direction (in this example, the Y-axis direction) is the direction orthogonal to the stacking direction (the X-axis direction) and the first direction (in this example, the Y-axis direction) (that is, the Z-axis direction).

In this example, the length L32 of the third shield 13 along the direction crossing the stacking direction (the X-axis direction) and the first direction (in this example, the Y-axis direction) is shorter than the length L12 along the crossing direction of the first shield 11.

That is, in the Y-axis direction and the Z-axis direction, the length of the third shield 13 is shorter than the length of the second shield 12. In the Y-axis direction and the Z-axis direction, the length of the third shield 13 is shorter than the length of the first shield 11.

The first magnetic layer 21 is provided between the first shield 11 and the third shield 13. The second magnetic layer 22 is provided between the first magnetic layer 21 and the third shield 13. The second magnetic layer 22 is exchange-coupled to the third shield 13. In other words, the third shield 13 is exchange-coupled to the second magnetic layer 22. The intermediate layer 25 is provided between the first magnetic layer 21 and the second magnetic layer 22.

The first magnetic layer 21, the second magnetic layer 22, and the intermediate layer 25 are included in a stacked body 20. It is assumed that also the third shield 13 is included in the stacked body 20 for the sake of convenience. In this example, the stacked body 20 further includes a foundation layer 26 and a nonmagnetic layer 27.

The foundation layer 26 is disposed between the first shield 11 and the second shield 12. The first magnetic layer 21 is disposed between the foundation layer 26 and the second shield 12. The intermediate layer 25 is disposed between the first magnetic layer 21 and the second shield 12. The second magnetic layer 22 is disposed between the intermediate layer 25 and the second shield 12. The nonmagnetic layer 27 is disposed between the second magnetic layer 22 and the second shield 12. The third shield 13 is disposed between the nonmagnetic layer 27 and the second shield 12. Examples of the configuration of the stacked body 20 are described later.

The magneto-resistance effect element according to the embodiment is mounted on a magnetic head, for example.

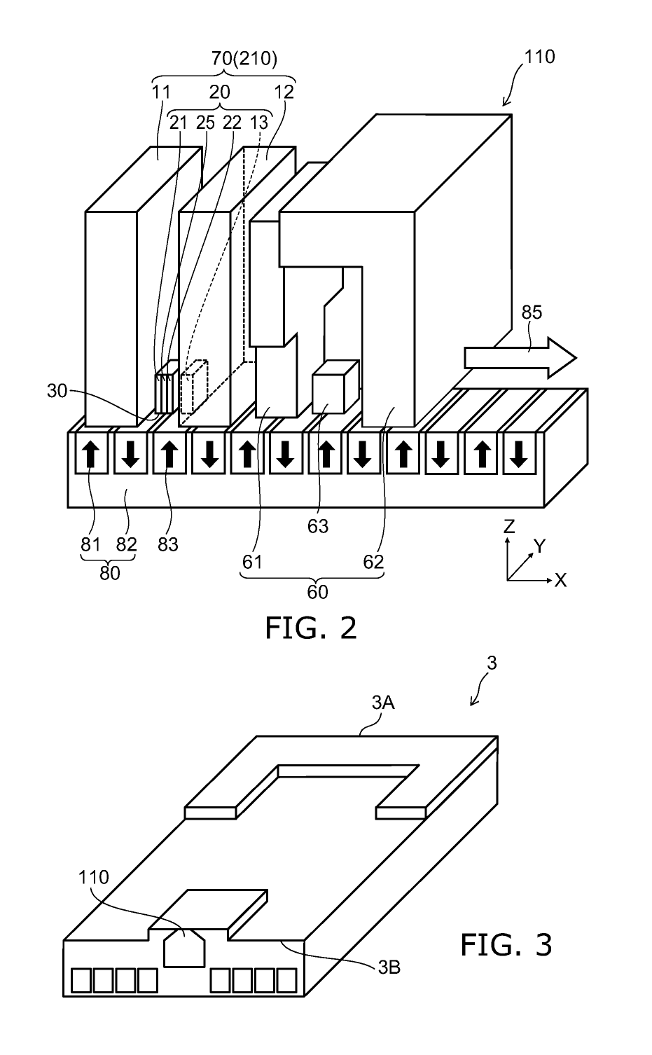

FIG. 2 is a schematic perspective view illustrating the configuration of a magnetic head in which the magneto-resistance effect element according to the first embodiment is mounted.

As shown in FIG. 2, the magneto-resistance effect element 210 according to the embodiment is mounted in a magnetic head 110. The magnetic head 110 includes a writing unit 60 and a reproducing unit 70. The writing unit 60 is apart from the reproducing unit 70. The direction from the reproducing unit 70 toward the writing unit 60 is taken as the X-axis direction, for example. The direction from the writing unit 60 toward the reproducing unit 70 may be the X-axis direction.

The writing unit 60 includes, for example, a main magnetic pole 61 and a writing unit return path 62. In the magnetic head 110, the writing unit 60 may further include a portion that assists the writing operation. In this example, a spin torque oscillator 63 (STO) is provided as the portion for assisting. In the magnetic head 110, the writing unit 60 may have an arbitrary configuration.

The reproducing unit 70 includes the magneto-resistance effect element 210. The components of the reproducing unit 70 and the writing unit 60 are separated by, for example, an insulator such as alumina (not shown).

A magnetic recording medium 80 includes, for example, a medium substrate 82 and a magnetic recording layer 81 provided on the medium substrate 82. The magnetization 83 of the magnetic recording layer 81 is controlled by a magnetic field applied from the writing unit 60, and thereby the writing operation is performed. The magnetic recording medium 80 moves relative to the magnetic head 110 along a medium moving direction 85.

The reproducing unit 70 is opposed to the magnetic recording medium 80. The reproducing unit 70 (the magneto-resistance effect element 210) has a medium facing surface (ABS; air bearing surface) 30 opposed to the magnetic recording medium 80. The magnetic recording medium 80 moves relative to the magnetic head 110 along the medium moving direction 85. The reproducing unit 70 detects the direction of the magnetization 83 of the magnetic recording layer 81. Thereby, the reproducing operation is performed. The reproducing unit 70 detects a recorded signal recorded in the magnetic recording medium 80.

The X-axis direction corresponds to, for example, the recording track traveling direction (track direction) of the magnetic recording medium 80. The Y-axis direction corresponds to, for example, the recording track width direction (track width direction) of the magnetic recording medium 80. The track width direction defines the bit width.

In the magneto-resistance effect element 210 included in the reproducing unit 70, for example, at least one of the direction of the magnetization of the first magnetic layer 21 and the direction of the magnetization of the second magnetic layer 22 changes in accordance with the medium magnetic field. A current is passed through the stacked body 20 along the stacking direction of the stacked body 20 to detect a recorded signal from the magnetic recording medium 80. Thereby, the reproducing unit 70 performs the reproducing operation. In the embodiment, the current is supplied to the stacked body 20 via the first shield 11 and the second shield 12. The first shield 11 and the second shield 12 function as electrodes.

FIG. 3 is a schematic perspective view illustrating the configuration of a head slider in which the magneto-resistance effect element according to the first embodiment is mounted.

As shown in FIG. 3, the magnetic head 110 including the magneto-resistance effect element 210 is mounted in a head slider 3. Al₂O₃/TiC or the like, for example, is used for the head slider 3. The head slider 3 moves relative to the magnetic recording medium 80 such as a magnetic disk while levitating above or being in contact with the magnetic recording medium 80.

The head slider 3 has, for example, an air inflow side 3A and an air outflow side 3B. The magnetic head 110 is disposed at the side surface on the air outflow side 3B of the head slider 3 or the like. Thereby, the magnetic head 110 mounted in the head slider 3 moves relative to the magnetic recording medium 80 while levitating above or being in contact with the magnetic recording medium 80.

Also any magneto-resistance effect element according to the embodiments described below is mounted in the magnetic head 110 similarly to the magneto-resistance effect element 210 illustrated in FIG. 2 and FIG. 3.

As shown in FIG. 1A to FIG. 1D, the stacked body 20 has a first side surface 20a and a second side surface 20b. The second side surface 20b is the side surface on the opposite side to the first side surface 20a. The first side surface 20a is, for example, parallel to the X-Y plane. In this example, also the second side surface 20b is parallel to the X-Y plane. The first side surface 20a forms part of the medium facing surface 30.

FIG. 1B corresponds to a plan view of the magneto-resistance effect element 210 as viewed from the medium facing surface 30.

In this example, the magneto-resistance effect element 210 includes a side shield 31, an insulating film 32, and a hard bias 33 in addition to the first shield 11, the second shield 12, and the stacked body 20.

The hard bias 33 is opposed to the second side surface 20b of the stacked body 20. That is, the hard bias 33 is provided on the opposite side of the stacked body 20 from the first side surface 20a (the medium facing surface 30). The hard bias 33 is provided between the first shield 11 and the second shield 12. A hard magnetic substance, for example, is used as the hard bias 33. The hard bias 33 applies a magnetic field to the stacked body 20 to set the magnetization of the first magnetic layer 21 and the second magnetic layer 22 to a prescribed direction.

The side shield 31 includes, for example, a first side shield unit 31a and a second side shield unit 31b. The second side shield unit 31b is apart from the first side shield unit 31a in the Y-axis direction. The first side shield unit 31a and the second side shield unit 31b are provided between the first shield 11 and the second shield 12. The stacked body 20 and the hard bias 33 are disposed between the first side shield unit 31a and the second side shield unit 31b. As the side shield 31, for example, at least one material selected from the group consisting of NiFe, CoZrNb, and CoZrTa, for example, is used.

The insulating film 32 is provided between the stacked body 20 and the hard bias 33 and between the stacked body 20 and the side shield 31. The insulating film 32 is further provided between the side shield 31 and the first shield 11 and between the hard bias 33 and the first shield 11. Silicon oxide (SiO₂), for example, is used as the insulating film 32.

A magnetic substance is used as the first shield 11, the second shield 12, and the third shield 13. The first shield 11, the second shield 12, and the third shield 13 include, for example, a ferromagnetic substance. At least one of the first shield 11, the second shield 12, and the third shield 13 includes, for example, at least one material selected from the group consisting of NiFe, CoZrTa, CoZrNb, CoZrNbTa, CoZrTaCr, and CoZrFeCr. A stacked film including a plurality of stacked layers including at least one material selected from these materials may be used as at least one of the first shield 11, the second shield 12, and the third shield 13. NiFe, for example, is used as at least one of the first shield 11, the second shield 12, and the third shield 13.

The material and configuration of the first shield 11 may be the same as or different from those of the second shield 12. The material and configuration of the first shield 11 may be the same as or different from those of the third shield 13. The material and configuration of the second shield 12 may be the same as or different from those of the third shield 13.

For example, NiFe may be used as the first shield 11 and the second shield 12, and CoZrNb may be used as the third shield 13.

The first shield 11 has a surface 11a parallel to the X-Y plane. The second shield 12 has, for example, a surface 12a parallel to the X-Y plane. The surface 11a and the surface 12a form part of the medium facing surface 30.

As the foundation layer 26, for example, at least one selected from the group consisting of Ta, Cu, and Ru may be used. Also a stacked film including a plurality of stacked layers including at least one material selected from these materials may be used as the foundation layer 26. The thickness (the length in the stacking direction) of the foundation layer 26 is, for example, 5 nanometers (nm) or less. In the case where a stacked film is used as the foundation layer 26, the thickness of each layer included in the stacked film is preferably 3 nm or less. As the foundation layer 26, for example, a stacked film (Ta/Cu) in which a layer including tantalum (Ta) with a thickness of 2 nm and a layer including copper (Cu) with a thickness of 2 nm are stacked may be used.

A ferromagnetic material, for example, is used for the first magnetic layer 21 and the second magnetic layer 22. CoFeGe, for example, is used for the first magnetic layer 21 and the second magnetic layer 22. The first magnetic layer 21 includes, for example, at least one material selected from the group consisting of CoFe, CoFeB, CoFeNi, CoFeSi, CoFeGe, CoFeSiGe, Co₂MnSi, Co₂MnGe, NiFe, CoFeMnSi, CoFeMnGe, and an Fe oxide (FeOₓ). Also a stacked film including a plurality of stacked layers including at least one material selected from these materials may be used as the first magnetic layer 21. The material and configuration of the second magnetic layer 22 may be the same as or different from those of the first magnetic layer 21.

The intermediate layer 25 is, for example, a nonmagnetic layer. Cu, for example, is used for the intermediate layer 25. The intermediate layer 25 includes, for example, at least one material selected from the group consisting of Cu, Ru, Au, Ag, Zn, Ga, TiOₓ, ZnO, Al₂O₃, MgO, InO, SnO, GaN, and tin-doped indium oxide (ITO; indium tin oxide). Also a stacked film including a plurality of stacked layers including at least one material selected from these materials may be used as the intermediate layer 25. The thickness of the intermediate layer 25 is 3 nm or less, for example approximately 3 nm.

The first magnetic layer 21 has a side surface 21a parallel to the X-Y plane. The second magnetic layer 22 has a side surface 22a parallel to the X-Y plane. The side surface 21a and the side surface 22a are exposed at the side surface 20a of the stacked body 20. The side surface 21a and the side surface 22a form part of the medium facing surface 30.

The position in the Z-axis direction of one end of the first magnetic layer 21 in the Z-axis direction orthogonal to the X-axis direction and the Y-axis direction (the side surface 21a) is the same as the position in the Z-axis direction of one end of the second magnetic layer 22 in the Z-axis direction (the side surface 22a), for example.

The thickness of the first magnetic layer 21 is 9 nm or less, for example approximately 5 nm. The thickness of the second magnetic layer 22 is 9 nm or less, for example approximately 5 nm. The thickness of the second magnetic layer 22 may be the same as or different from the thickness of the first magnetic layer 21. By setting the thickness of the first magnetic layer 21 and the second magnetic layer 22 as thin as 9 nm or less, the thickness of the stacked body 20 can be made thin. By thinning the thickness of the stacked body 20, the distance between the first shield 11 and the second shield 12 can be made small, and the recording density of the HDD can be increased.

The nonmagnetic layer 27 includes, for example, at least one material selected from the group consisting of Cu, Ru, Au, Ag, Rh, Pt, Pd, Cr, and Ir. Ru, for example, is used for the nonmagnetic layer 27. The thickness of the nonmagnetic layer 27 is 2 nm or less, for example 1.5 nm.

As described above, the length L31 along the Y-axis direction (the first direction) of the third shield 13 is shorter than the length L21 along the Y-axis direction of the second shield 12. The length L31 is, for example, 20 nm (e.g. not less than 3 nm and not more than 50 nm). The length 21 is, for example, not less than 1 micrometer (μm) and not more than 3 μm.

As described above, the length L32 along the Z-axis direction of the third shield 13 is shorter than the length L22 along that direction of the second shield 12. The length L32 is, for example, 20 nm (e.g. not less than 3 nm and not more than 50 nm). The length L22 along the Z-axis direction of the second shield 12 is, for example, not less than 1 μm and not more than 100 μm.

The third shield 13 is in contact with the second shield 12.

The state where the third shield 13 is in contact with the second shield 12 includes the state where the third shield 13 is physically near to the second shield 12, within the extent that the third shield 13 functions as a shield. The state where the third shield 13 is in contact with the second shield 12 includes, for example, the state where the third shield 13 is physically in contact with the second shield 12. The state where the third shield 13 is in contact with the second shield 12 includes, for example, the state where contaminants due to manufacturing processes or other layers formed are interposed between the second shield 12 and the third shield 13, within the extent that the third shield 13 has the function as a shield.

The state where the third shield 13 is in contact with the second shield 12 can be checked by, for example, physically observing a cross section of the magneto-resistance effect element 210 from the Z-axis direction perpendicular to the medium facing surface 30 or the Y-axis direction orthogonal to the Z-axis direction using TEM (transmission electron microscopy) or the like. The state where the third shield 13 is in contact with the second shield 12 can be checked from, for example, the fact that the third shield 13 functions as a shield.

The fact that the third shield 13 functions as a shield can be checked by investigating the resolution of the magneto-resistance effect element 210 in a HDD or a spin stand. It is investigated whether the resolution is defined by the correlation with the distance between the first shield 11 and the second shield 12 or defined by the correlation with the distance between the first shield 11 and the third shield 13. When the third shield 13 functions as a shield, the resolution is defined by the correlation with the distance between the first shield 11 and the third shield 13. In this case, it can be concluded that the third shield 13 is in contact with the second shield 12.

The third shield 13 may be continuous with the second shield 12. The third shield 13 may be integrated with the second shield 12. That is, they are formed in one body. The state of being integrated includes, for example, the state where there is no atomic size step at the interface between the second shield 12 and the third shield 13. The state of being integrated includes, for example, the case of being continuous at the interface between the third shield 13 and the second shield 12. The state of being integrated includes, for example, the state where the third shield 13 includes the same material as the material included in the second shield 12.

As described above, the third shield 13 is exchange-coupled to the second magnetic layer 22. For example, the third shield is antiferromagnetically coupled to the second magnetic layer 22. When the nonmagnetic layer 27 includes, for example, at least one material selected from the group consisting of Cu, Ru, Au, Ag, Rh, Pt, Pd, Cr, and Ir, the exchange coupling between the third shield 13 and the second magnetic layer 22 is ensured based on the RKKY interaction.

The exchange coupling includes, for example, direct joining between a magnetic layer and a magnetic layer. The exchange coupling includes, for example, magnetic coupling between magnetic layers acting via a prescribed ultrathin nonmagnetic layer provided between the magnetic layers, in a plurality of magnetic layers. The exchange coupling is an effect lying across the interface between a magnetic layer and a magnetic layer or the interface between a magnetic layer and a nonmagnetic layer. In the case of lying across the interface between a magnetic layer and a nonmagnetic layer, the exchange coupling depends on the film thickness of the nonmagnetic layer, and acts when the thickness of the nonmagnetic layer is 2 nm or less. The exchange coupling is different from static magnetic field coupling due to a leak magnetic field from the end portion of a magnetic layer.

The exchange coupling energy can be considered as a ferromagnetic coupling bias magnetic field or an antiferromagnetic coupling bias magnetic field acting between magnetic layers. For example, in the case where there is no applied magnetic field bias or the like from the outside, by the exchange coupling action, the directions of the magnetizations of the magnetic layers can be equalized to the same direction (the ferromagnetic coupling state), or can be set to opposite directions (the antiferromagnetic coupling state). In the case where there is an applied magnetic field bias or the like from the outside, the magnetization is directed to the direction determined by the synthesis of the applied magnetic field bias magnetic field from the outside and the bias magnetic field due to the exchange coupling. Thus, although the direction of the bias magnetic field due to the exchange coupling does not necessarily agree with the directions of the magnetizations of the magnetic layers, the ferromagnetic coupling bias magnetic field components or the antiferromagnetic coupling magnetic field components due to the exchange coupling acts. In the case of the magneto-resistance effect element 210 of the embodiment, there is also a bias magnetic field due to the hard bias 33 in addition to the bias magnetic field due to the exchange coupling.

The thickness of the third shield 13 is, for example, not less than 1 nm and not more than 9 nm. The thickness of the third shield 13 can be found from, for example, the observation of the medium facing surface 30 using TEM.

The area of the surface where the third shield 13 is opposed to the second magnetic layer 22 is preferably not less than 9 square nanometers (nm²) and not more than 2500 nm². As described later, the area is more preferably not less than 25 nm² and not more than 900 nm². The area of the surface where the third shield 13 is opposed to the second magnetic layer 22 can be found from, for example, the observation of a cross section orthogonal to the medium facing surface 30 and the Y-axis direction using TEM.

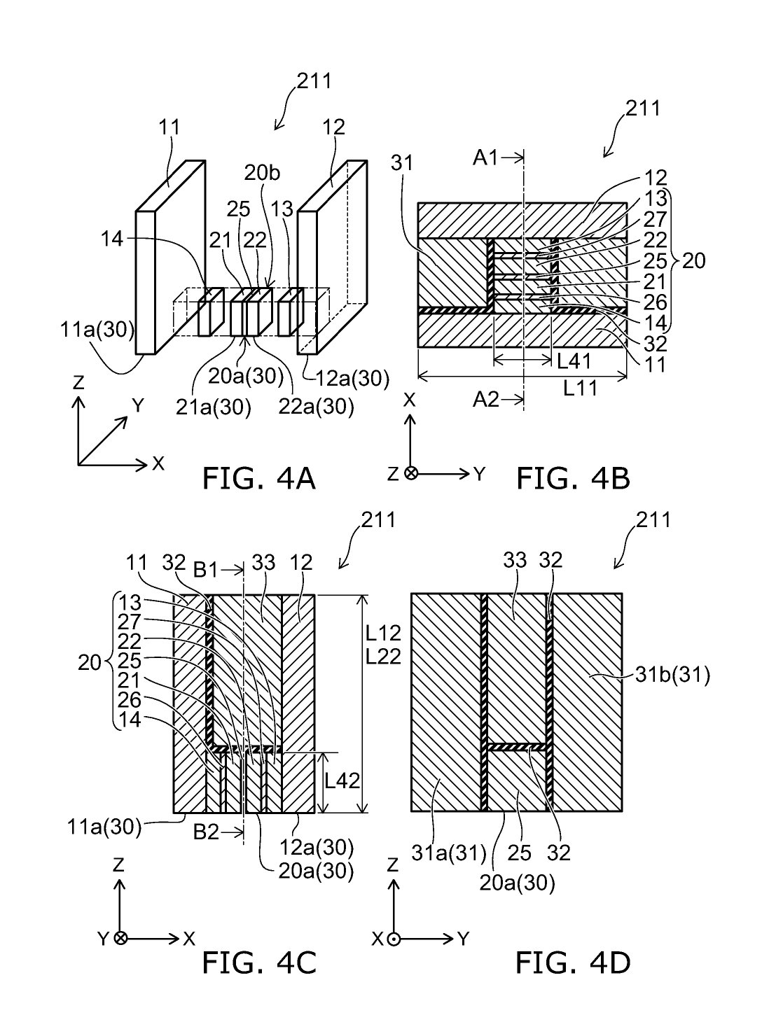

FIG. 4A to FIG. 4D are schematic views illustrating the configuration of another magneto-resistance effect element according to the first embodiment.

FIG. 4A is a disassembled perspective view. FIG. 4B is a plan view (a plan view as viewed from the medium facing surface). FIG. 4C is a cross-sectional view taken along line A1-A2 of FIG. 4B. FIG. 4D is a cross-sectional view taken along line B1-B2 of FIG. 4C. In FIG. 4A, the illustration of some layers is omitted for easier viewing of the drawing.

As shown in FIG. 4A to FIG. 4D, in another magneto-resistance effect element 211 according to the embodiment, a fourth shield 14 is provided. The fourth shield 14 is included in the stacked body 20 for the sake of convenience. Differences of the magneto-resistance effect element 211 from the magneto-resistance effect element 210 will now be described.

The magneto-resistance effect element 211 further includes the fourth shield 14. The fourth shield 14 is provided between the first shield 11 and the first magnetic layer 21. The fourth shield 14 is exchange-coupled to the first magnetic layer 21. In other words, the first magnetic layer 21 is exchange-coupled to the fourth shield 14. For example, the fourth shield 14 is antiferromagnetically coupled to the first magnetic layer 21.

The fourth shield 14 has a length L41 along the first direction (in this example, the Y-axis direction). The fourth shield 14 has a length L42 along a second direction crossing the stacking direction (the X-axis direction) and the first direction (the Y-axis direction). In this example, the second direction is set to the Z-axis direction. The length L41 is shorter than the length L11 along the first direction of the first shield 11. The length L42 is shorter than the length L12 along the second direction (the Z-axis direction) of the first shield.

The fourth shield 14 has at least one of a length L41 along the first direction shorter than the length L11 along the first direction of the first shield 11 and a length L42 along the second direction shorter than the length L12 along the second direction of the first shield 11.

The length L41 along the Y-axis direction of the fourth shield 14 is, for example, 20 nm (e.g. not less than 3 nm and not more than 50 nm). The length L11 along the Y-axis direction of the first shield 11 is, for example, not less than 1 μm and not more than 3 μm.

The length L42 along the Z-axis direction of the fourth shield 14 is, for example, 20 nm (e.g. not less than 3 nm and not more than 50 nm). The length L12 along the Z-axis direction of the first shield 11 is, for example, not less than 1 μm and not more than 100 μm.

A magnetic substance is used for the fourth shield 14. For example, a ferromagnetic substance is used for the fourth shield 14. The fourth shield 14 includes, for example, at least one material selected from the group consisting of NiFe, CoZrTa, CoZrNb, CoZrNbTa, CoZrTaCr, and CoZrFeCr. Also a stacked film including a plurality of stacked layers including at least one material selected from these materials may be used for the fourth shield 14. The material and configuration of the fourth shield 14 may be the same as or different from those of the first shield 11, the second shield 12, and the third shield 13.

As mentioned above, the fourth shield 14 is in contact with the first shield 11.

The state where the fourth shield 14 is in contact with the first shield 11 includes the state where the fourth shield 14 is physically near to the first shield 11, within the extent that the fourth shield 14 functions as a shield. The state where the fourth shield 14 is in contact with the first shield 11 includes, for example, the state where the fourth shield 14 is physically in contact with the first shield 11. The state where the fourth shield 14 is in contact with the first shield 11 includes, for example, the state where contaminants due to manufacturing processes or other layers formed are interposed between the first shield 11 and the fourth shield 14, within the extent that the fourth shield 14 has the function as a shield.

The state where the fourth shield 14 is in contact with the first shield 11 can be checked by, for example, physically observing a cross section of the magneto-resistance effect element 211 from the Z-axis direction perpendicular to the medium facing surface 30 or the Y-axis direction perpendicular to the Z-axis direction using TEM or the like. The state where the fourth shield 14 is in contact with the first shield 11 can be checked by, for example, the fact that the fourth shield 14 functions as a shield.

The fact that the fourth shield 14 functions as a shield can be checked by investigating the resolution of the magneto-resistance effect element 211 in a HDD or a spin stand. It is investigated whether the resolution is defined by the correlation with the distance between the first shield 11 and the second shield 12 or defined by the correlation with the distance between the third shield 13 and the fourth shield 14. When the fourth shield 14 functions as a shield, the resolution is defined by the correlation with the distance between the third shield 13 and the fourth shield 14. In this case, it can be concluded that the fourth shield 14 is in contact with the first shield 11.

The fourth shield 14 may be continuous with the first shield 11. The fourth shield 14 may be integrated with the first shield 11. That is, they are formed in one body. The state of being integrated includes, for example, the state where there is no atomic size step at the interface between the first shield 11 and the fourth shield 14. The state of being integrated includes, for example, the case of being continuous at the interface between the fourth shield 14 and the first shield 11. The state of being integrated includes, for example, the state where the fourth shield 14 includes the same material as the material included in the first shield 11.

The material of the fourth shield 14 may be, for example, different from the material of the first shield 11.

The thickness of the fourth shield 14 is, for example, not less than 1 nm and not more than 9 nm. As described later, the area of the surface where the fourth shield 14 is opposed to the first magnetic layer 21 is preferably not less than 25 nm² and not more than 900 nm².

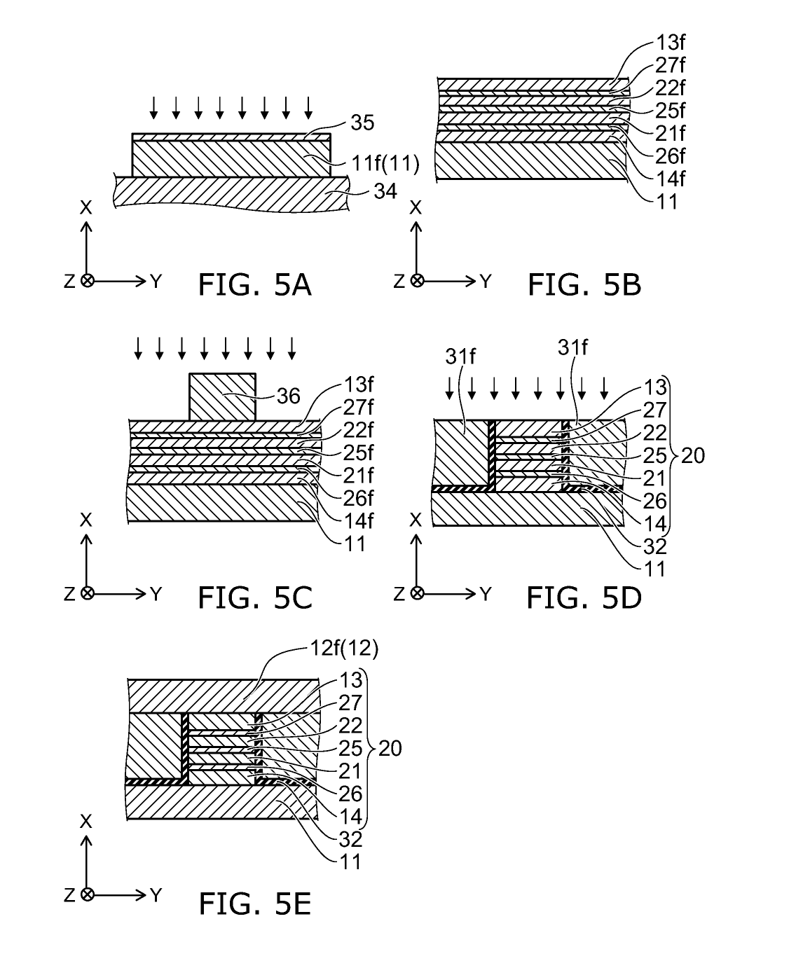

FIG. 5A to FIG. 5E are schematic cross-sectional views in order of the processes, illustrating a method for manufacturing the magneto-resistance effect element according to the first embodiment.

The drawings show a method for manufacturing the magneto-resistance effect element 211.

As shown in FIG. 5A, for example, a substrate 34 is placed in a chamber (not shown). A first shield film 11f that forms the first shield 11 is formed on the substrate 34. The first shield film 11f is formed by, for example, electric plating. After a deposit of the material that forms the first shield film 11f is formed on the substrate 34, for example, the surface of the deposit is ground.

A mask pattern 35 is formed on the first shield film 11f using photoresist technology, and the mask pattern 35 is used as a mask to etch the first shield film 11f, for example. Thereby, the first shield 11 is formed on the substrate 34. Ion beam etching, for example, is used as the etching. After that, the mask pattern 35 is removed.

The interior of the chamber is reduced in pressure (for example, made vacuum), and the upper surface of the first shield 11 is etched with an ion beam. Thereby, the oxidized layer and the contamination layer formed on the upper surface of the first shield 11 are removed. The oxidized layer is, for example, what is formed by exposure to the air after the electric plating and grinding. The contamination layer is, for example, what is attached during the manufacturing processes. In FIG. 5B to FIG. 5E, the illustration of the substrate 34 is omitted.

As shown in FIG. 5B, while the pressure in the chamber is reduced, a fourth shield film 14f that forms the fourth shield 14 is formed on the first shield 11 so as to be in contact with the first shield 11. Next, a foundation film 26f that forms the foundation layer 26 is formed on the fourth shield film 14f. A first magnetic film 21f that forms the first magnetic layer 21 is formed on the foundation film 26f. An intermediate film 25f that forms the intermediate layer 25 is formed on the first magnetic film 21f. A second magnetic film 22f that forms the second magnetic layer 22 is formed on the intermediate film 25f. A nonmagnetic film 27f that forms the nonmagnetic layer 27 is formed on the second magnetic film 22f. A third shield film 13f that forms the third shield 13 is formed on the nonmagnetic film 27f.

As shown in FIG. 5C, a mask pattern 36 is formed on the third shield film 13f. As the mask pattern 36, for example, a resist mask or a metal mask including Ta is used. The mask pattern 36 is formed by, for example, using optical lithography technology.

The configuration of the upper surface of the mask pattern 36 defines the width in a direction orthogonal to the stacking direction of the stacked body 20. The mask pattern 36 is slimmed to fashion the upper surface of the mask pattern 36 into a prescribed configuration. For example, the area of the upper surface of the mask pattern 36 is made not less than 9 nm² and not more than 2500 nm². For example, each of the widths of the stacked body 20 in the directions orthogonal to the stacking direction is made 20 nm. Thereby, for example, a surface recording density of 2 terabits per square inch area (2 Tb/inch²) is obtained.

As shown in FIG. 5D, the mask pattern 36 is used as a mask to pattern the third shield film 13f, the nonmagnetic film 27f, the second magnetic film 22f, the intermediate film 25f, the first magnetic film 21f, the foundation film 26f, and the fourth shield film 14f. Thereby, the stacked body 20 including the fourth shield 14, the foundation layer 26, the first magnetic layer 21, the intermediate layer 25, the second magnetic layer 22, the nonmagnetic layer 27, and the third shield 13 is formed on the first shield 11.

In the case where, for example, a portion in the thickness direction of the fourth shield film 14f is removed, the portion with the greater thickness of the fourth shield film 14f forms the fourth shield 14. The portion with the smaller thickness of the fourth shield film 14f is regarded as part of the first shield 11.

In the case where the entire portion not covered with the mask pattern 36 of the fourth shield film 14f is removed, the fourth shield film 14f covered with the mask pattern 36 and remaining forms the fourth shield 14. The first shield film 11f forms the first shield.

On the other hand, over-etching may be performed to reduce the thickness of part of the portion not covered with the mask pattern 36 of the first shield film 11f. In this case, the portion with the greater thickness of the first shield film 11f and the remaining portion of the fourth shield film 14f form the fourth shield 14.

Next, the insulating film 32 that covers the side surface of the stacked body 20 is formed. Next, a side shield film 31f that forms the side shield 31 is formed so as to cover the side surface of the stacked body 20 via the insulating film 32 by, for example, the sputtering method. A hard bias film (not shown in this drawing) that forms the hard bias 33 is formed on the stacked body 20. After that, the insulating film 32, the side shield film 31f, and the hard bias film are planarized from the upper side.

Next, the upper surface of the third shield 13 is etched with an ion beam. Thereby, the mask pattern 36 remaining on the upper surface of the third shield and the oxidized layer and the contamination layer formed on the upper surface of the third shield are removed. Thus, the cleaned surface of the third shield 13 is exposed.

Next, as shown in FIG. 5E, a second shield film 12f that forms the second shield 12 is formed on the third shield 13. The formation of the second shield film 12f is performed without exposure to the air after the ion beam etching of the upper surface of the third shield 13. Then, the second shield film 12f is patterned to form the second shield 12. The second shield 12 is in contact with the third shield 13.

When the second shield film 12f can be formed without exposure to the air and the second shield 12 can be formed in contact with the third shield 13 after the ion beam etching, other processes may exist between the process illustrated in FIG. 5D and the process illustrated in FIG. 5E.

Thus, the magneto-resistance effect element 211 is fabricated.

By omitting the formation of the fourth shield film 14f in the processes mentioned above, the magneto-resistance effect element 210 is fabricated.

Characteristics of the magneto-resistance effect elements 210 and 211 under the following conditions will now be described. As the first shield 11 and the second shield 12, NiFe is used. As the third shield 13, CoZrNb (thickness: 5 nm) is used. As the fourth shield 14, CoZrNb (thickness: 5 nm) is used. As the foundation layer 26, a stacked film of Ta (thickness: 2 nm)/Cu (thickness: 2 nm) is used. As the nonmagnetic layer 26 and the nonmagnetic layer 27, Ru (thickness: 1.5 nm) is used. As the first ferromagnetic layer 21 and the second ferromagnetic layer 22, CoFeGe (thickness: 5 nm) is used. As the intermediate layer 25, Cu (thickness: 3 nm) is used. The length L31 along the Y-axis direction of the third shield 13 and the length L32 along the Z-axis direction of the third shield 13 are 20 nm. The length L41 along the Y-axis direction of the fourth shield 14 and the length L42 along the Z-axis direction of the fourth shield 14 are 25 nm.

The area of the third shield 13 opposing the second magnetic layer 22 in the magneto-resistance effect elements 210 and 211 is 400 nm². Also characteristics when the area of the surface opposed to the second magnetic layer 22 of the third shield 13 was changed were simulated. The area of the surface opposed to the first magnetic layer 21 of the fourth shield 14 is 625 nm². Also characteristics when the area of the surface opposed to the first magnetic layer 21 of the fourth shield 14 was changed were simulated.

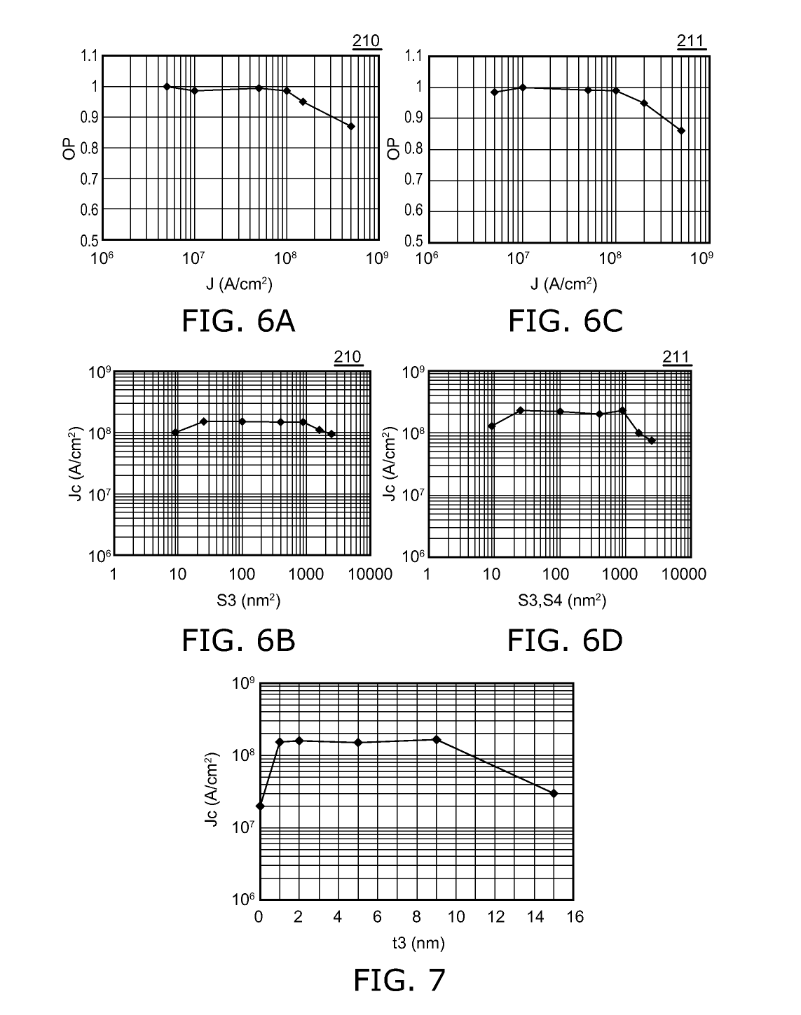

FIG. 6A to FIG. 6D are graphs illustrating characteristics of the magneto-resistance effect element according to the first embodiment.

FIG. 6A and FIG. 6B correspond to the magneto-resistance effect element 210. FIG. 6C and FIG. 6D correspond to the magneto-resistance effect element 211.

FIG. 6A and FIG. 6C are measurement results of the output voltage when the external applied magnetic field is set to 0 (oersteds; Oe) and a current is passed between the first shield 11 and the second shield 12. The horizontal axis of FIG. 6A and FIG. 6C represents the current density J (A/cm²) of the current flowing through the stacked body 20 (the first magnetic layer 21). The vertical axis represents the normalized output voltage Op (an arbitrary unit).

The horizontal axis of FIG. 6B and FIG. 6D represents the area S3 (nm²) of the surface opposed to the second magnetic layer 22 of the third shield 13. The vertical axis represents the critical current density Jc (A/cm²).

As shown in FIG. 6A, in the magneto-resistance effect element 210, an almost fixed value is exhibited as the output voltage Op in a range of the current density J of not less than 5.0×10⁶ A/cm² and not more than 1.0×10⁸ A/cm². When the current density J exceeds 1.5×10⁸ A/cm², the output voltage Op decreases. The current density J at the point when the output voltage Op has decreased from the maximum value by 5% is taken as the critical current density Jc. The critical current density Jc in the magneto-resistance effect element 210 is 1.5×10⁸ (A/cm²).

Also a magneto-resistance effect element of a first reference example in which the third shield 13 is not provided has been fabricated. The magneto-resistance effect element of the first reference example has the same configuration as the magneto-resistance effect element 210 except that the third shield 13 is not provided. The magneto-resistance effect element of the first reference example is a common three-layer structure (trilayer head) magneto-resistance effect element. In the first reference example, the critical current density Jc is 1.8×10⁷ A/cm².

Also a magneto-resistance effect element of a second reference example has been fabricated in which, before forming the third shield film 13f in the manufacturing method mentioned above, the nonmagnetic film 27f, the second magnetic film 22f, the intermediate film 25f, the first magnetic film 21f, the foundation film 26f, and the fourth shield film 14f are patterned using the mask pattern 36, then the third shield film 13f and the second shield film 13f are formed, and the third shield 13 is made the same shape as the second shield 12. In the magneto-resistance effect element of the second reference example, the critical current density Jc was 2.0×10⁷ A/cm².

Thus, in the magneto-resistance effect element 210 according to the embodiment in which the third shield 13 is provided, the critical current density Jc is much larger than the critical current density Jc of the first and second reference examples.

Thus, in the magneto-resistance effect element 210 according to the embodiment, the critical current density Jc can be made large. That is, spin torque noise can be suppressed.

In the embodiment, the length L31 along the Y-axis direction of the third shield 13 is set shorter than the length L21 in the Y-axis direction of the second shield 12, and the length L31 is equal or close to the length along the Y-axis direction of the second magnetic layer 22. Thereby, the magnitude of the effective magnetic field of the third shield 13 is brought close to the magnitude of the effective magnetic field of the second magnetic layer 22. Thereby, the ferromagnetic resonance frequency of the third shield 13 can be brought close to the ferromagnetic resonance frequency of the first magnetic layer 21 and the second magnetic layer 22, which is a main frequency component of the spin torque noise. Thereby, the interaction effect between the third shield 13 and the first magnetic layer 21 and the interaction effect between the third shield 13 and the second magnetic layer 22 are strengthened, and spin torque noise can be suppressed.

By the embodiment, the critical current density Jc of the magneto-resistance effect element can be increased. This means that a current can be passed through the magneto-resistance effect element at a high current density. Even when the magneto-resistance effect element is miniaturized, the influence of spin torque noise can be reduced to increase the critical current density Jc, and a high output voltage can be obtained. The embodiment can miniaturize the magneto-resistance effect element. Thus, the recording density can be increased.

As shown in FIG. 6B, in the configuration of the magneto-resistance effect element 210, the critical current density Jc is 10⁸ A/cm² or more when the area S3 of the surface opposed to the second magnetic layer 22 of the third shield 13 is not less than 9 nm² and not more than 2500 nm². The critical current density Jc is still higher when the area S3 is not less than 25 nm² and not more than 900 nm². The area S3 is more preferably not less than 25 nm² and not more than 900 nm².

As shown in FIG. 6C, in the magneto-resistance effect element 211, an almost fixed value is exhibited as the output voltage Op in a range of the current density J of not less than 5.0×10⁶ A/cm² and not more than 1.0×10⁸ A/cm². When the current density is 2.0×10⁸ A/cm² or more, the output voltage Op decreases. In the magneto-resistance effect element 211, the critical current density Jc is 2.0×10⁸ A/cm².

Also a magneto-resistance effect element of a third reference example having the following configuration has been fabricated. In the third reference example, the third shield 13 and the fourth shield 14 are not provided. In the third reference example, the length along the Y-axis direction and the length along the Z-axis direction of the third shield 13 can be regarded as the same as the length along the Y-axis direction and the length along the Z-axis direction of the second shield 12, and the length along the Y-axis direction and the length along the Z-axis direction of the fourth shield 14 can be regarded as the same as the length along the Y-axis direction and the length along the Z-axis direction of the first shield 11. In the third reference example, the film-formation of the third shield film 13f is performed in the same process as the film-formation of the second shield film 12f. By using end point monitor control in patterning, the patterning is stopped at the time when the etching of the second magnetic layer 22 has finished, and the fourth shield film 14f is not etched. The critical current density Jc of the magneto-resistance effect element of the third reference example is 2.1×10⁷ A/cm².

Thus, in the magneto-resistance effect element 211 in which the third shield 13 and the fourth shield 14 are provided, the critical current density Jc is much larger than the critical current density Jc of the first to third reference examples.

In the embodiment, the fourth shield 14 is provided in addition to the third shield 13. The length L41 along the Y-axis direction of the fourth shield 14 is shorter than the length L11 along the Y-axis direction of the first shield 11. The length L41 is equal or close to the length along the Y-axis direction of the first magnetic layer 21. Thereby, the magnitude of the effective magnetic field of the fourth shield 14 is brought close to the magnitude of the effective magnetic field of the first magnetic layer 21. Thereby, the ferromagnetic resonance frequency of the fourth shield 14 can be brought close to the ferromagnetic resonance frequency of the first magnetic layer 21 and the second magnetic layer 22, which is a main frequency component of the spin torque noise. Thus, the interaction effect between the fourth shield 14 and the first magnetic layer 21 and the interaction effect between the fourth shield 14 and the second magnetic layer 22 are added in addition to the interaction effect between the third shield 13 and the first magnetic layer 21 and the interaction effect between the third shield 13 and the second magnetic layer 22; thereby, spin torque noise can be further suppressed.

Thus, the critical current density Jc in the magneto-resistance effect element 211 can be further increased than the critical current density Jc in the magneto-resistance effect element 210. In the magneto-resistance effect element 211, even when it is further miniaturized, the influence of spin torque noise can be reduced to increase the critical current density Jc, and a high output voltage can be obtained. By the magneto-resistance effect element 211, the magneto-resistance effect element can be further miniaturized and the recording density can be further increased.

FIG. 6D illustrates characteristics when, in the configuration of the magneto-resistance effect element 211, the area S4 of the surface opposed to the first magnetic layer 21 of the fourth shield 14 is set to the same as the area S3 of the surface opposed to the second magnetic layer 22 of the third shield 13, and the area S3 and the area S4 are changed.

As shown in FIG. 6D, when the area S3 and the area S4 are not less than 25 nm² and not more than 900 nm², a large critical current density Jc of 2.0×10⁸ A/cm² or more is obtained.

FIG. 7 is a graph illustrating characteristics of the magneto-resistance effect element according to the first embodiment.

FIG. 7 illustrates the simulation results of the critical current density Jc when the thickness t3 of the third shield 13 is changed in the configuration of the magneto-resistance effect element 210. The horizontal axis of FIG. 7 represents the thickness t3 (nm), and the vertical axis represents the critical current density Jc.

As shown in FIG. 7, in the magneto-resistance effect element 210, the critical current density Jc is large when the thickness t3 of the third shield 13 is not less than 1 nm and not more than 9 nm. Under this condition, a larger critical current density Jc of 1.0×10⁸ A/cm² or more is obtained. The thickness t3 of the third shield 13 is preferably not less than 1 nm and not more than 9 nm.

In the magneto-resistance effect elements 210 and 211, in the case where a stacked film including a plurality of stacked layers including at least one material selected from the group consisting of Ta, Cu, and Ru is used as the foundation layer 26, good crystal orientation can be ensured in the stacked body 20. Thereby, high sensitivity reproduction characteristics are obtained in the magneto-resistance effect elements 210 and 211.

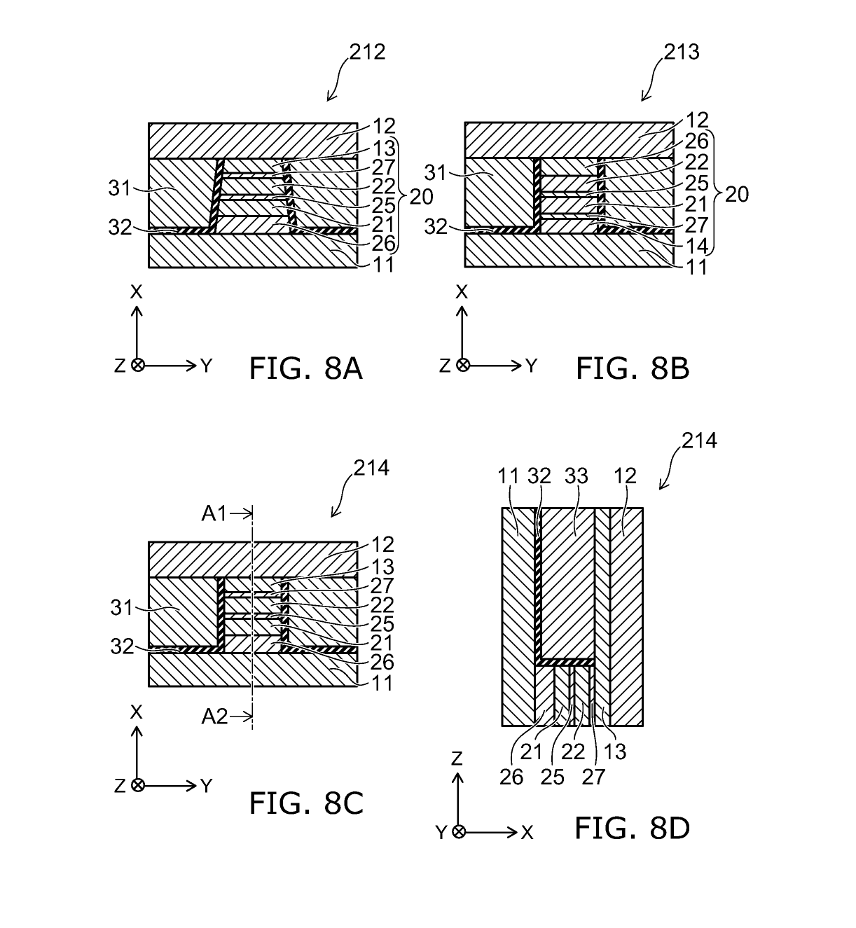

FIG. 8A to FIG. 8D are schematic views illustrating the configurations of other magneto-resistance effect elements according to the first embodiment.

FIG. 8A is a plan view of a magneto-resistance effect element 212 as viewed from the medium facing surface. FIG. 8B is a plan view of a magneto-resistance effect element 213 as viewed from the medium facing surface. FIG. 8C is a plan view of a magneto-resistance effect element 214 as viewed from the medium facing surface. FIG. 8D is a cross-sectional view taken along line A1-A2 of FIG. 8C.

As shown in FIG. 8A, in the magneto-resistance effect element 212 according to the embodiment, the length along the Y-axis direction of the stacked body 20 changes along the X-axis direction. The length along the Y-axis direction of the portion on the first shield 11 side of the stacked body 20 is longer than the length along the Y-axis direction of the portion on the second shield 12 side of the stacked body 20. The side surface of the stacked body 20 is in a tapered shape. Also in the magneto-resistance effect element 212, the length along the first direction of the third shield 13 is shorter than the length along the first direction of the second shield 12.

As shown in FIG. 8B, in the magneto-resistance effect element 213 according to the embodiment, the stacked body 20 has a configuration in which the fourth shield 14, the nonmagnetic layer 27, the first magnetic layer 21, the intermediate layer 25, the second magnetic layer 22, and the foundation layer 26 are stacked in this order from the first shield 11 side toward the second shield 12 side. That is, the third shield 13 is not formed, but the fourth shield 14 is formed. In the above description, by replacing the first shield 11 and the second shield 12 with each other and replacing the first magnetic layer 21 and the second magnetic layer 22 with each other, the fourth shield 14 can be regarded as the third shield 13. The length along the first direction of the fourth shield 14 regarded as the third shield 13 is shorter than the length along the first direction of the second shield 12 regarded as the first shield 11.

As shown in FIG. 8C and FIG. 8D, in the magneto-resistance effect element 214, the length in the Y-axis direction of the third shield 13 is shorter than the length in the Y-axis direction of the second shield 12. The length in the Z-axis direction of the third shield 13 is not shorter than, for example the same as, the length in the Z-axis direction of the second shield 12.

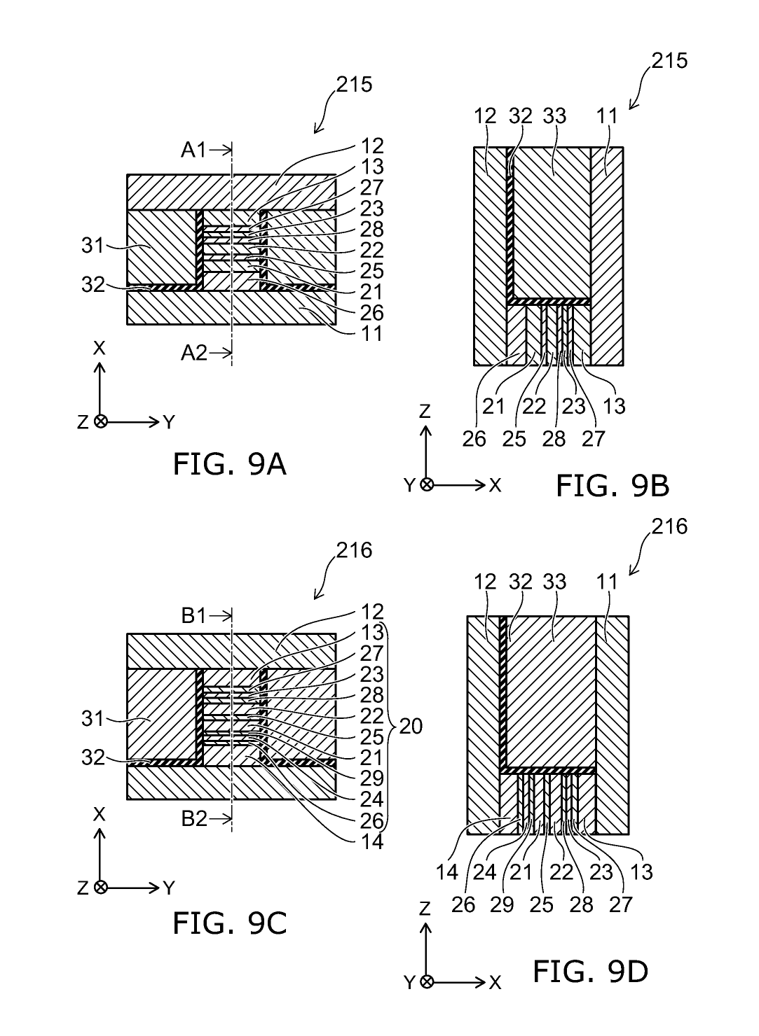

FIG. 9A to FIG. 9D are schematic views illustrating the configurations of other magneto-resistance effect elements according to the first embodiment.

FIG. 9A is a plan view of a magneto-resistance effect element 215 as viewed from the medium facing surface. FIG. 9B is a cross-sectional view taken along line A1-A2 of FIG. 9A. FIG. 9C is a plan view of a magneto-resistance effect element 216 as viewed from the medium facing surface. FIG. 9D is a cross-sectional view taken along line B1-B2 of FIG. 9C.

As shown in FIG. 9A and FIG. 9B, in the magneto-resistance effect element 215 according to the embodiment, a third magnetic layer 23 and a nonmagnetic layer 28 are provided between the second magnetic layer 22 and the third shield 13. In this example, the nonmagnetic layer 27 is provided, and the third magnetic layer 23 and the nonmagnetic layer 28 are provided between the second magnetic layer 22 and the nonmagnetic layer 27. The nonmagnetic layer 28 is provided between the second magnetic layer 22 and the third magnetic layer 23.

For the third magnetic layer 23, for example, at least one material selected from the group consisting of CoFe, CoFeSi, and CoFeGe is used. The thickness of the third magnetic layer 23 is, for example, 2 nm or less.

For the nonmagnetic layer 28, for example, at least one material selected from the group consisting of Cu, Ru, Au, Ag, Rh, Pt, Pd, Cr, and Ir may be used.

In the magneto-resistance effect element 215, the third magnetic layer 23 adjusts the strength of the exchange coupling between the third shield 13 and the second magnetic layer 22. The third magnetic layer 23 is, for example, an exchange coupling adjustment layer.

If the thickness of the third magnetic layer 23 and the thickness of the nonmagnetic layer 28 are 2 nm or more, the interaction effect between the third shield 13 and the second magnetic layer 22 is weakened, and the effect of suppressing spin torque noise may be reduced.

Also in the magneto-resistance effect element 215, the length along the first direction of the third shield 13 is shorter than the length along the first direction of the second shield 12.

As shown in FIG. 9C and FIG. 9D, in the magneto-resistance effect element 216 according to the embodiment, the fourth shield 14 is provided, and a fourth magnetic layer 24 and a nonmagnetic layer 29 are further provided. The fourth magnetic layer 24 is disposed between the fourth shield 14 and the first magnetic layer 21. The nonmagnetic layer 29 is disposed between the fourth magnetic layer 24 and the first magnetic layer 21.

For the fourth magnetic layer 24, for example, at least one material selected from the group consisting of CoFe, CoFeSi, and CoFeGe may be used. The thickness of the fourth magnetic layer 24 is, for example, 2 nm or less.

In the magneto-resistance effect element 216, for example, the fourth magnetic layer 24 adjusts the strength of the exchange coupling between the fourth shield 14 and the first magnetic layer 21. The fourth magnetic layer 24 is, for example, an exchange coupling adjustment layer.

If the thickness of the fourth magnetic layer 24 and the thickness of the nonmagnetic layer 28 are 2 nm or more, the interaction effect between the fourth shield 14 and the first magnetic layer 21 is weakened, and the effect of suppressing spin torque noise may be reduced.

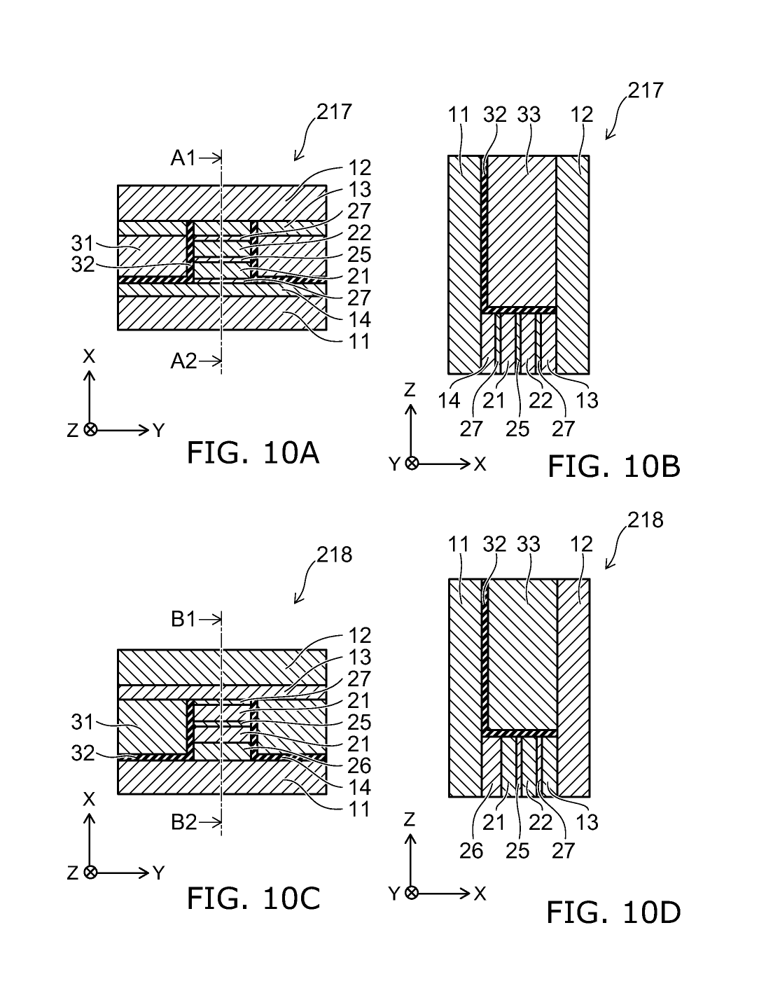

FIG. 10A to FIG. 10D are schematic views illustrating the configurations of other magneto-resistance effect elements according to the first embodiment.

FIG. 10A is a plan view of a magneto-resistance effect element 217 as viewed from the medium facing surface. FIG. 10B is a cross-sectional view taken along line A1-A2 of FIG. 10A. FIG. 10C is a plan view of a magneto-resistance effect element 218 as viewed from the medium facing surface. FIG. 10D is a cross-sectional view taken along line B1-B2 of FIG. 10C.

As shown in FIG. 10A and FIG. 10B, in the magneto-resistance effect element 217 according to the embodiment, the length along the Y-axis direction of the third shield 13 and the length along the Y-axis direction of the fourth shield 14 are not shorter than the length along the Y-axis direction of the first shield 11 and the length along the Y-axis direction of the second shield 12. On the other hand, the length along the Z-axis direction of the third shield 13 and the length along the Z-axis direction of the fourth shield are shorter than the length along the Z-axis direction of the first shield 11 and the length along the Z-axis direction of the second shield 12. The first direction and the second direction may be exchanged for each other, for example.

Also in the magneto-resistance effect element 217, the length along the first direction (in this case, the Z-axis direction) of the third shield 13 is shorter than the length along the first direction (the Z-axis direction) of the second shield 12. The length along the first direction of the fourth shield 14 is shorter than the length along the first direction of the first shield 11.

As shown in FIG. 10C and FIG. 10D, in the magneto-resistance effect element 218 according to the embodiment, the length along the Y-axis direction of the third shield 13 is not shorter than the length along the Y-axis direction of the second shield 12. On the other hand, the length along the Z-axis direction of the third shield 13 is shorter than the length along the Z-axis direction of the second shield 12.

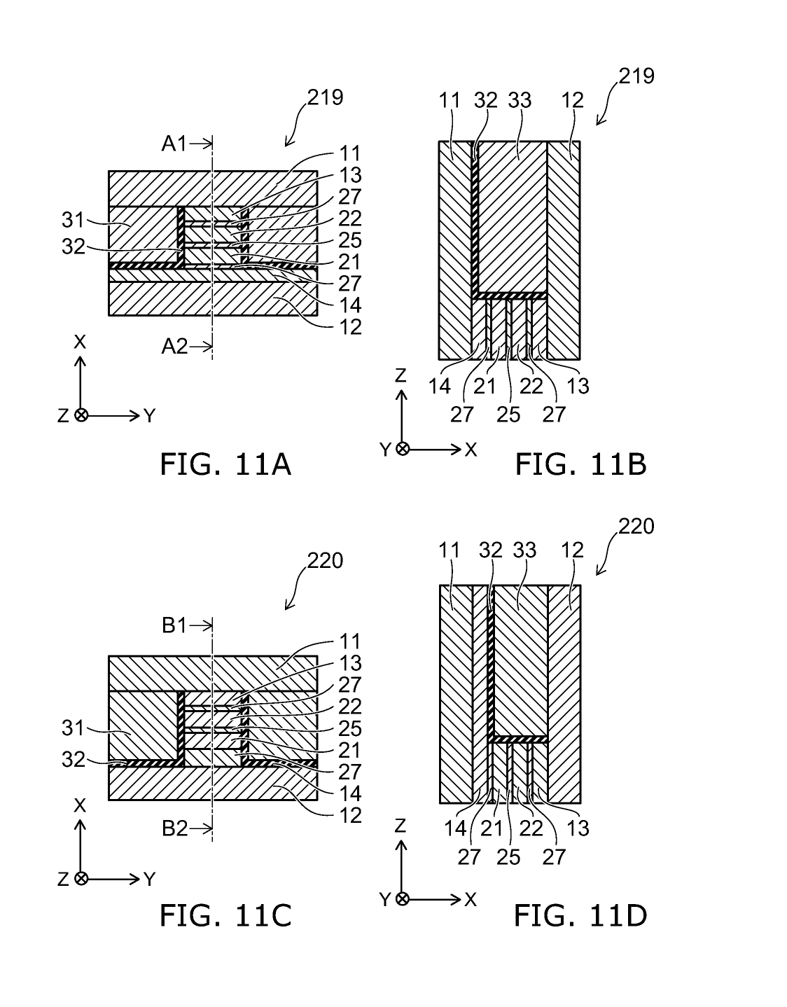

FIG. 11A to FIG. 11D are schematic views illustrating the configurations of other magneto-resistance effect elements according to the first embodiment.

FIG. 11A is a plan view of a magneto-resistance effect element 219 as viewed from the medium facing surface. FIG. 11B is a cross-sectional view taken along line A1-A2 of FIG. 11A. FIG. 11C is a plan view of a magneto-resistance effect element 220 as viewed from the medium facing surface. FIG. 11D is a cross-sectional view taken along line B1-B2 of FIG. 11C.

As shown in FIG. 11A and FIG. 11B, in the magneto-resistance effect element 219 according to the embodiment, the length along the Y-axis direction of the fourth shield 14 is not shorter than the length along the Y-axis direction of the first shield 11. On the other hand, the length along the Z-axis direction of the fourth shield 14 is shorter than the length along the Z-axis direction of the first shield 11.

As shown in FIG. 11C and FIG. 11D, in the magneto-resistance effect element 220 according to the embodiment, the length along the Y-axis direction of the fourth shield 14 is shorter than the length along the Y-axis direction of the first shield 11. On the other hand, the length along the Z-axis direction of the fourth shield 14 is not shorter than, for example the same as, the length along the Z-axis direction of the first shield 11.

Also in the magneto-resistance effect elements 212 to 220, the influence of spin torque noise can be reduced to increase the critical current density Jc, miniaturization is possible, and the recording density can be further increased.

### SECOND EMBODIMENT

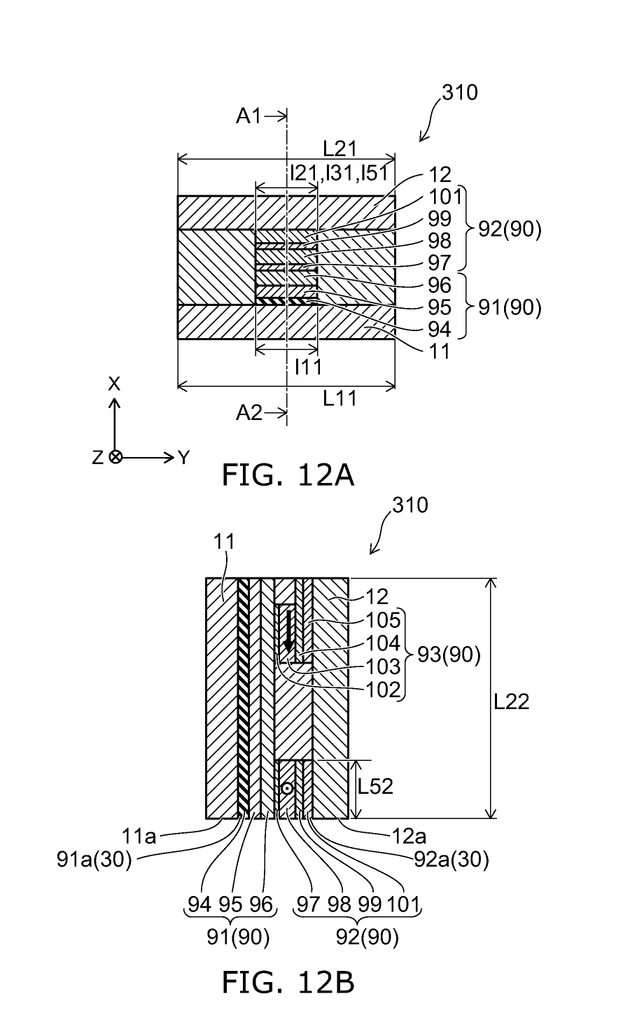

FIG. 12A and FIG. 12B are schematic views illustrating the configuration of a magneto-resistance effect element according to a second embodiment.

FIG. 12A is a plan view of a magneto-resistance effect element 310 according to the embodiment as viewed from the medium facing surface. FIG. 12B is a cross-sectional view taken along line A1-A2 of FIG. 12A.

As shown in FIG. 12A and FIG. 12B, the magneto-resistance effect element 310 according to the embodiment includes the first shield 11, the second shield 12, and a stacked body 90.

The second shield 12 is apart from the first shield 11 in the X-axis direction. The second shield 12 has, for example, the surface 12a parallel to the X-Y plane. The surface 12a forms part of the medium facing surface 30. Also the first shield 11 has the surface 11a parallel to the X-Y plane. Also the surface 11a forms part of the medium facing surface 30.

The stacked body 90 is provided between the first shield 11 and the second shield 12. The stacking direction in the stacked body 90 is the X-axis direction (the direction from the first shield 11 toward the second shield 12).

The stacked body 90 includes a first stacked portion 91, a second stacked portion 92, and a third stacked portion 93. The second stacked portion 92 and the third stacked portion 93 are disposed between the first stacked portion 91 and the second shield 12.

One side surface 91a (e.g. a side surface 91a parallel to the X-Y plane) of the first stacked portion 91 forms part of the medium facing surface 30. The length l11 along the Y-axis direction of the first stacked portion 91 is shorter than the length L11 along the Y-axis direction of the first shield 11 and the length L21 along the Y-axis direction of the second shield 12.

The third stacked portion 93 is apart from the second stacked portion 92 in the Z-axis direction between the first stacked portion 91 and the second shield 12. The third stacked portion 93 is apart from the medium facing surface 30.

The length l21 along the Y-axis direction of the second stacked portion 92 is shorter than the length L11 along the Y-axis direction of the first shield 11 and the length L21 along the Y-axis direction of the second shield 12. The length l31 along the Y-axis direction of the third stacked portion 93 is shorter than the length L11 along the Y-axis direction of the first shield 11 and the length L21 along the Y-axis direction of the second shield 12. One side surface 92a (e.g. a side surface 92a parallel to the X-Y plane) of the second stacked portion 92 forms part of the medium facing surface 30.

The first stacked portion 91 includes, for example, an insulating layer 94, a foundation layer 95, and a nonmagnetic layer 96. The foundation layer 95 is disposed between the insulating layer 94 and the second shield 12, and the nonmagnetic layer 96 is disposed between the foundation layer 95 and the second shield 12.

For the insulating layer 94, for example, silicon oxide (SiO₂) is used. The thickness of the insulating layer 94 is 3 nm or less. For example, it is 3 nm.

For the foundation layer 95, for example, tantalum (Ta) is used. The thickness of the foundation layer 95 is 2 nm or less, for example 2 nm.

For the nonmagnetic layer 96, for example, copper (Cu) is used. The thickness of the nonmagnetic layer 96 is 5 nm or less, for example 5 nm.

The second stacked portion 92 includes, for example, an intermediate layer 97, a first magnetic layer 98, a nonmagnetic layer 99, and a third shield 101. The first magnetic layer 98 is disposed between the intermediate layer 97 and the second shield 12, the nonmagnetic layer 99 is disposed between the first magnetic layer 98 and the second shield 12, and the third shield 101 is disposed between the nonmagnetic layer 99 and the second shield 12.

For the intermediate layer 97, for example, magnesium oxide (MgO) is used. The thickness of the intermediate layer 97 is 1 nm or less. For example, it is 1 nm.

For the first magnetic layer 98, for example, a ferromagnetic substance is used. For example, CoFeGe is used for the first magnetic layer 98. The thickness of the first magnetic layer is 5 nm or less, for example 5 nm.

For the nonmagnetic layer 99, for example, Ru is used. The thickness of the nonmagnetic layer 99 is 2 nm or less, for example 1.5 nm.

For the third shield 101, for example, CoZrNb is used. The thickness of the third shield 101 is 5 nm or less, for example 5 nm. The third shield 101 is in contact with the second shield 12. The area of the surface where the third shield 101 is opposed to the first magnetic layer 98 is, for example, approximately 400 nm² (not less than 25 nm² and not more than 900 nm²). The widths of two sides of the surface where the third shield 101 is opposed to the first magnetic layer 98 are, for example, each 20 nm.

The length of the third shield 101 along the first direction crossing (e.g. orthogonal to) the stacking direction is shorter than the length along the first direction of the second shield. The first direction is, for example, the Y-axis direction. The length l51 along the Y-axis direction of the third shield 101 (in this example, the same as the length l21) is shorter than the length L21 along the Y-axis direction of the second shield 12. In this example, the length l52 along the Z-axis direction of the third shield 101 is shorter than the length L22 along the Z-axis direction of the second shield 12.

The third stacked portion 93 includes, for example, an intermediate layer 102, a second magnetic layer 103, a first electrode unit 104, and an insulating layer 105. The second magnetic layer 103 is disposed between the intermediate layer 102 and the second shield 12, the first electrode unit 104 is disposed between the second magnetic layer 103 and the second shield 12, and the insulating layer 105 is disposed between the first electrode unit 104 and the second shield 12.

For the intermediate layer 102, for example, magnesium oxide (MgO) is used. The thickness of the intermediate layer 102 is 1 nm or less, for example 1 nm.

As the second magnetic layer 103, for example, a stacked film of a layer including CoFeGe and a layer including IrMn is used. The thickness of the layer including CoFeGe is 5 nm or less, for example 5 nm. The thickness of the layer including IrMn is 5 nm or less, for example 5 nm.

For the first electrode unit 104, for example, copper (Cu) is used. The thickness of the first electrode unit 104 is 3 nm or less, for example 3 nm.

For the insulating layer 105, for example, silicon oxide (SiO₂) is used. The thickness of the insulating layer 105 is 3 nm or less, for example 3 nm.

The magneto-resistance effect element 310 according to the embodiment has a two-terminal electrode structure in which the first electrode unit 104 and the second shield 12 are used as electrodes. In the magneto-resistance effect element 310, for example, a current path in the order of the first electrode unit 104, the second magnetic layer 103, the intermediate layer 102, the nonmagnetic layer 96, the intermediate layer 97, the first magnetic layer 98, the nonmagnetic layer 99, the third shield 101, and the second shield 12 is provided.

When, for example, a current is passed from the second shield 12 to the first electrode unit 104, spins are injected by the current into the second magnetic layer 103 in which the direction of the magnetization is fixed. The injected spins become a polarization state in which the directions of the magnetic moments are made uniform by the second magnetic layer 103. Thereby, a reproduction output signal can be obtained by the resistance change due to the relative angle between the direction of the spin that has become the polarization state and the direction of the magnetization of the first magnetic layer 98 that is a free layer. In such reproduction element driving using a two-terminal electrode structure, the current path of spin injection and reproduction output signal detection are not separated. This driving is, for example, local-type driving.

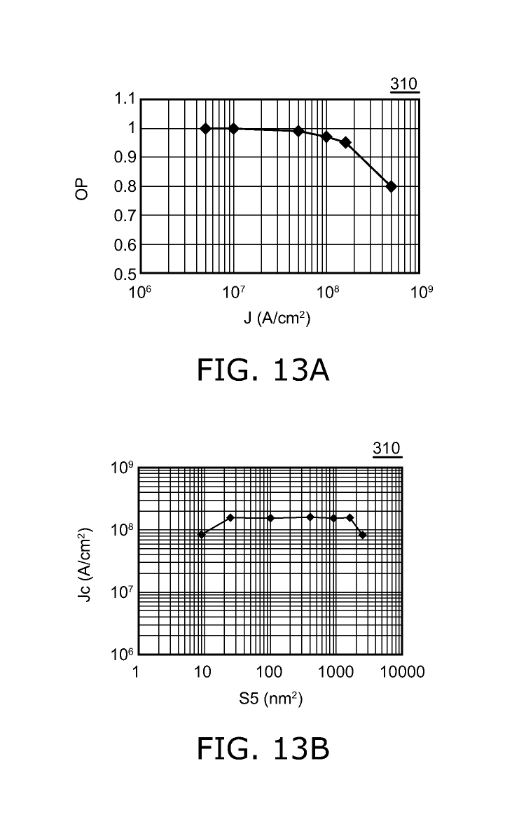

FIG. 13A and FIG. 13B are graphs illustrating characteristics of the magneto-resistance effect element according to the second embodiment.

FIG. 13A is measurement results of the output voltage when the external applied magnetic field is set to 0 (Oe) and a current is passed between the first electrode unit 104 and the second shield 12. The horizontal axis of FIG. 13A represents the current density J of the current flowing through the stacked body 20 (the first magnetic layer 21). The vertical axis represents the normalized output voltage Op. The horizontal axis of FIG. 13B represents the area S5 (nm²) of the surface opposed to the first magnetic layer 98 of the third shield 101. The vertical axis represents the critical current density Jc.

As shown in FIG. 13A, an almost fixed value is exhibited as the output voltage Op in a range of the current density J of not less than 5.0×10⁶ A/cm² and not more than 1.6×10⁸ A/cm². When the current density J exceeds 1.6×10⁸ A/cm², the output voltage Op decreases. In the magneto-resistance effect element 310, the critical current density Jc is 1.6×10⁸ A/cm².

In a magneto-resistance effect element of a fourth reference example, a nonmagnetic layer of a stacked structure is provided in place of the nonmagnetic layer 99 and the third shield 101 in the magneto-resistance effect element 310. The nonmagnetic layer has a stacked structure of a layer including tantalum (Ta) with a thickness of 1.5 nm and a layer including Ru with a thickness of 5 nm. In the magneto-resistance effect element of the fourth reference example, the critical current density Jc is 3.0×10⁷ A/cm².

In a magneto-resistance effect element of a fifth reference example, the film-formation of the third shield 101 is performed in the same process as the film-formation of the second shield 12 in the magneto-resistance effect element 310. That is, since the fifth shield 101 is not etched, the lengths in the Y-axis direction and the Z-axis direction of the third shield 101 are the same as the lengths in the Y-axis direction and the Z-axis direction of the second shield 12. In the magneto-resistance effect element of the fifth reference example, the critical current density Jc is 3.5×10⁷ A/cm².

Thus, in the magneto-resistance effect element 310 according to the embodiment, the critical current density Jc can be made larger than in the fourth and fifth reference examples. In the embodiment, the length along the Y-axis direction of the third shield 101 is set shorter than the length along the Y-axis direction of the second shield 12. Thereby, spin torque noise can be suppressed.

By the embodiment, the influence of spin torque noise can be reduced to increase the critical current density Jc, miniaturization is possible, and the recording density can be further increased.

As shown in FIG. 13B, in the magneto-resistance effect element 310, the critical current density Jc is large when the area S5 of the opposition of the third shield 101 to the first magnetic layer 98 is not less than 9 nm² and not more than 2500 nm². When the area S5 is not less than 25 nm² and not more than 900 nm², a large critical current density Jc of 10⁸ A/cm² or more can be obtained.

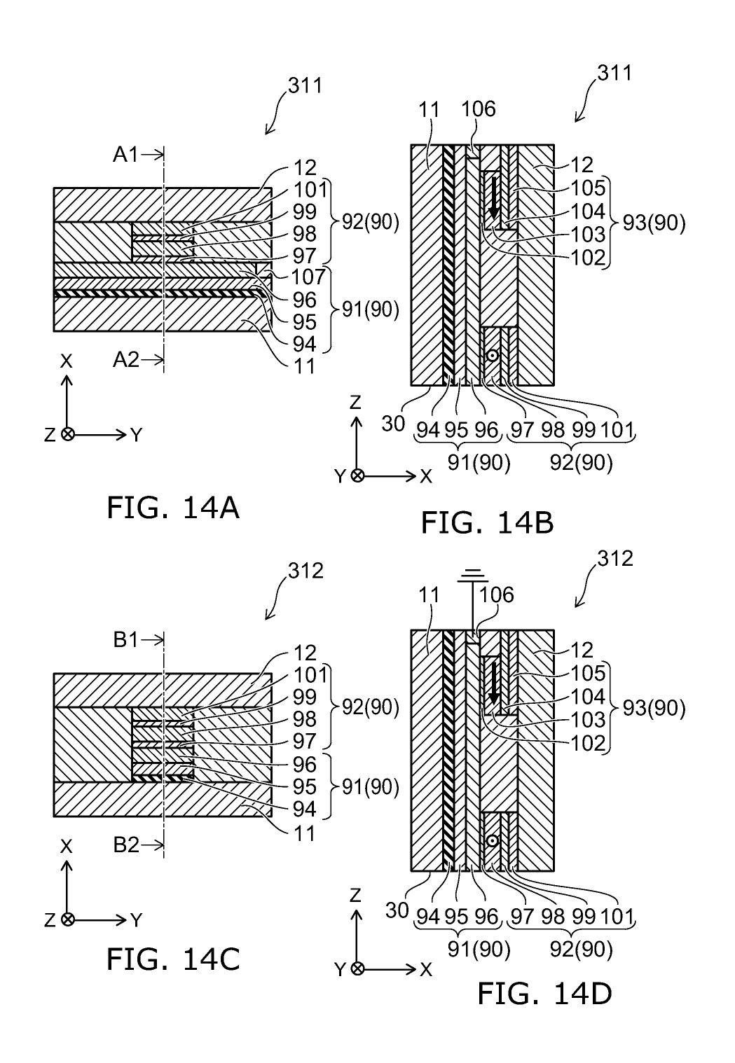

FIG. 14A to FIG. 14D are schematic views illustrating the configurations of other magneto-resistance effect elements according to the second embodiment.

FIG. 14A is a plan view of a magneto-resistance effect element 311 as viewed from the medium facing surface. FIG. 14B is a cross-sectional view taken along line A1-A2 of FIG. 14A. FIG. 14C is a plan view of a magneto-resistance effect element 312 as viewed from the medium facing surface. FIG. 14D is a cross-sectional view taken along line B1-B2 of FIG. 14C.

As shown in FIG. 14A and FIG. 14B, in the magneto-resistance effect element 311 according to the embodiment, the length along the Y-axis direction of the first stacked portion 91 is not shorter than the length along the Y-axis direction of the first shield 11. A second electrode unit 106 is provided at an end of the nonmagnetic layer 96 on the opposite side to the medium facing surface 30. A third electrode unit 107 is provided at an end of the nonmagnetic layer 96 on the medium facing surface 30 side. In the magneto-resistance effect element 311, a four-terminal electrode structure is used.

A first current source is connected to the first electrode unit 104 and the second electrode unit 106, for example. A current is passed to inject spins into the second magnetic layer 103 in which the direction of the magnetization is fixed. Thereby, diffusive spins polarized in the direction of the magnetization of the second magnetic layer 103 are accumulated in a portion of the nonmagnetic layer 96 around the lower portion of the intermediate layer 97.

A second voltage source is connected to the second shield 12 and the third electrode unit 106. Thereby, the magneto-resistance change due to the relative angle between the direction of the polarized diffusive spins accumulated in the portion of the nonmagnetic layer 96 around the lower portion of the intermediate layer 97 and the direction of the magnetization of the first magnetic layer 98 that is a free layer is detected. The magneto-resistance change corresponds to a reproduction output signal.

In the four-terminal electrode structure of the embodiment, the current path for spin injection is separated from reproduction output signal detection. In the magneto-resistance effect element 311, a non-local structure is used.

As shown in FIG. 14C and FIG. 14D, in the magneto-resistance effect element 312 according to the embodiment, the length along the Y-axis direction of the first stacked portion 91 is shorter than the length along the Y-axis direction of the first shield 11. The second electrode unit 106 is provided at an end of the nonmagnetic layer 96 on the opposite side to the medium facing surface 30. The third electrode unit 107 is not provided. In the magneto-resistance effect element 312, a three-terminal electrode structure is used.

The magneto-resistance effect element 312 corresponds to the case where the electric potential of the third electrode unit 107 is set to the same as the electric potential of the second electrode unit 106 in the magneto-resistance effect element 311 mentioned above. In the magneto-resistance effect element 312, the first current source is connected to the first electrode unit 104 and the second electrode unit 107, and the second voltage source is connected to the second shield 12 and the second electrode unit 106. Thereby, the magneto-resistance change is detected.

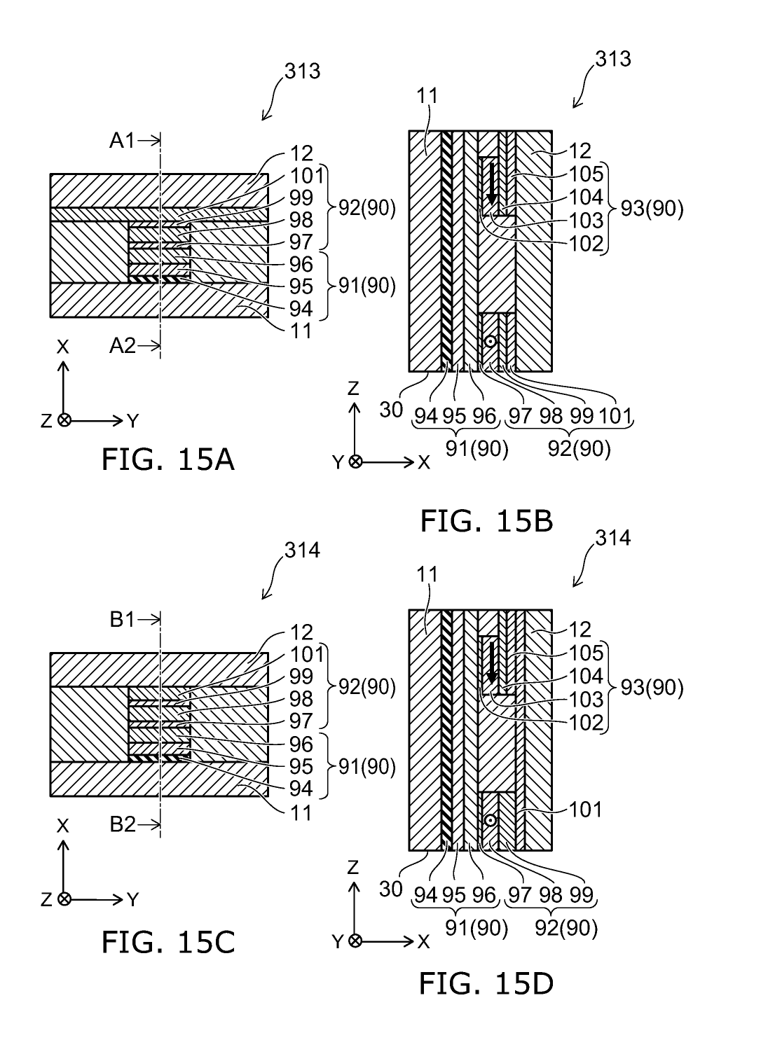

FIG. 15A to FIG. 15D are schematic views illustrating the configurations of other magneto-resistance effect elements according to the second embodiment.

FIG. 15A is a plan view of a magneto-resistance effect element 313 as viewed from the medium facing surface. FIG. 15B is a cross-sectional view taken along line A1-A2 of FIG. 15A. FIG. 15C is a plan view of a magneto-resistance effect element 314 as viewed from the medium facing surface. FIG. 15D is a cross-sectional view taken along line B1-B2 of FIG. 15C.

As shown in FIG. 15A and FIG. 15B, in the magneto-resistance effect element 313 according to the embodiment, the length along the Y-axis direction of the third shield 101 is not shorter than the length along the Y-axis direction of the second shield 12. The length along the Z-axis direction of the third shield 101 is shorter than the length along the Z-axis direction of the second shield 12. Also in this case, spin torque noise can be suppressed.

As shown in FIG. 15C and FIG. 15D, in the magneto-resistance effect element 314 according to the embodiment, the length along the Z-axis direction of the third shield 101 is not shorter than the length along the Z-axis direction of the second shield 12. The third shield 101 extends up to between the third stacked portion 93 and the second shield 12.

Also in the magneto-resistance effect elements 311 to 314, the influence of spin torque noise can be reduced to increase the critical current density Jc, miniaturization is possible, and the recording density can be further increased.

### THIRD EMBODIMENT

The magnetic head according to the embodiments described above may, for example, be incorporated in an integrated recording/reproducing magnetic head assembly and be installed in a magnetic recording and reproducing apparatus. The magnetic recording and reproducing apparatus according to the embodiment may have only the reproducing function or both the recording function and the reproducing function.

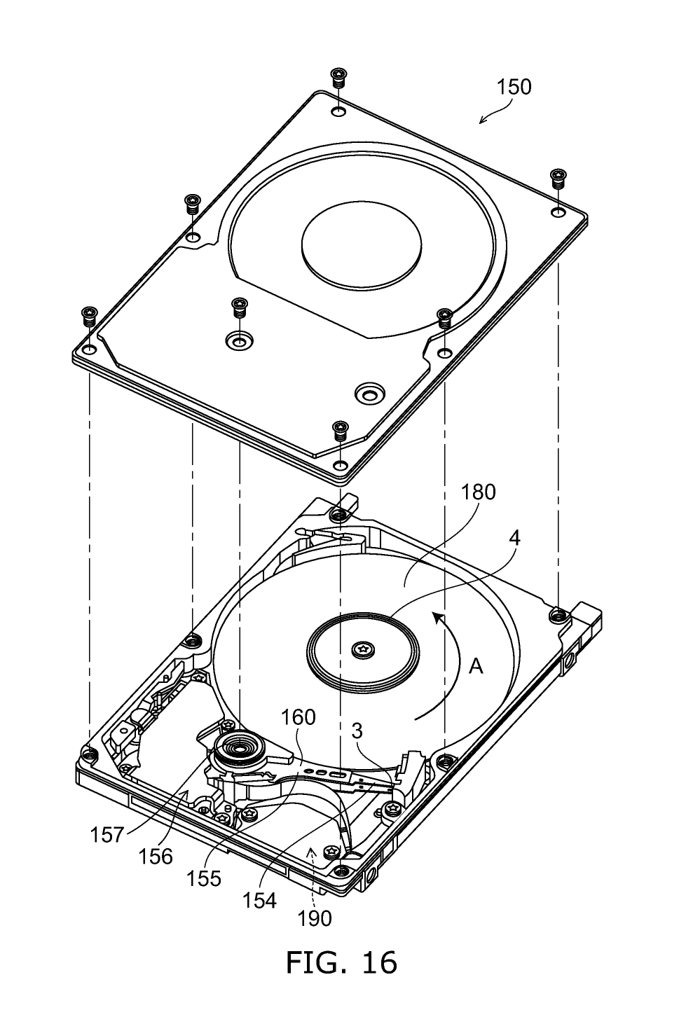

FIG. 16 is a schematic perspective view illustrating the configuration of a magnetic recording and reproducing apparatus according to a third embodiment.

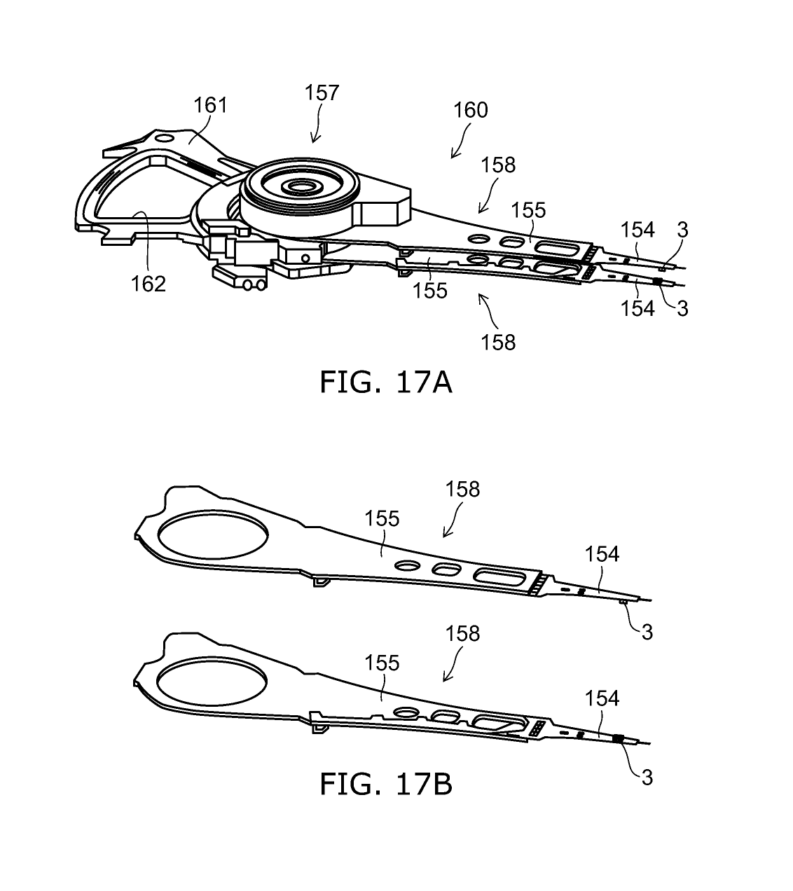

FIG. 17A and FIG. 17B are schematic perspective views illustrating the configuration of part of a magnetic recording apparatus according to the third embodiment.

As shown in FIG. 16, a magnetic recording and reproducing apparatus 150 according to the embodiment is an apparatus of a system using a rotary actuator. A recording medium disk 180 is mounted on a spindle motor 170. The recording medium disk 180 is rotated in the direction of arrow A by a not-shown motor. The motor responds to a control signal from a not-shown driving device control unit, for example. The magnetic recording and reproducing apparatus 150 according to the embodiment may include a plurality of recording medium disks 180. Only one side of the recording medium disk 180 may be used.

The recording and reproduction of information stored in the recording medium disk 180 are performed by the head slider 3. The head slider 3 has the configuration illustrated above. The head slider 3 is provided at the tip of a suspension 154. The suspension 154 is in a thin film form. The magnetic head 110 according to the embodiment described above, for example, is mounted near the tip of the head slider 3. Any of the magneto-resistance effect elements 210 to 220 and 310 to 314 according to the first and second embodiments and magneto-resistance effect elements modified based on them is provided in the magnetic head 110.

When the recording medium disk 180 rotates, the head slider 3 is held above the surface of the recording medium disk 180. That is, the pressing pressure by the suspension 154 and the pressure generated at the medium facing surface (ABS) of the head slider 3 are balanced. Thereby, the distance between the medium facing surface of the head slider 3 and the surface of the recording medium disk 180 is kept at a prescribed value. In the embodiment, also what is called a “contact-traveling type” may be used in which the head slider 3 is in contact with the recording medium disk 180.

The suspension 154 is connected to one end of an actuator arm 155. The actuator arm 155 includes, for example, a bobbin that holds a not-shown driving coil and the like. A voice coil motor 156 is provided at the other end of the actuator arm 155. The voice coil motor 156 is, for example, a kind of linear motor. The voice coil motor 156 may include, for example, a not-shown driving coil and a magnetic circuit. The driving coil is, for example, wound around the bobbin of the actuator arm 155. The magnetic circuit may include, for example, a not-shown permanent magnet and a not-shown opposed yoke. The permanent magnet and the opposed yoke are opposed to each other, and the driving coil is disposed between them.

The actuator arm 155 is held by not-shown ball bearings, for example. The ball bearings are, for example, provided at two positions, the top and bottom, of a bearing portion 157. The actuator arm 155 can rotationally slide freely by means of the voice coil motor 156. Consequently, the magnetic head can be moved to an arbitrary position on the recording medium disk 180. A signal processing unit 190 is provided that uses the magnetic head to perform the writing and reading of signals on the magnetic recording medium.

The signal processing unit 190 is provided on the back side, in the drawing, of the magnetic recording and reproducing apparatus 150, for example. The input/output lines of the signal processing unit 190 are connected to the electrode pads of a magnetic head assembly 158 to be electrically connected to the magnetic head.

That is, the signal processing unit 190 is electrically connected to the magnetic head.

The change in the resistance of the magneto-resistance effect element in accordance with the medium magnetic field recorded in the magnetic recording medium 80 is detected by, for example, the signal processing unit 190.

Thus, the magnetic recording and reproducing apparatus 150 according to the embodiment includes the magnetic head according to the embodiments mentioned above, a movable unit that allows the magnetic recording medium and the magnetic head to move relatively in a state of keeping both apart or in contact, a position control unit that positions the magnetic head at a prescribed recording position on the magnetic recording medium, and the signal processing unit that uses the magnetic head to perform the writing and reading of signals on the magnetic recording medium.

That is, the recording medium disk 180 is used as the magnetic recording medium 80 mentioned above. The movable unit mentioned above may include the head slider 3. The position control unit mentioned above may include the magnetic head assembly 158.

Thus, the magnetic recording and reproducing apparatus 150 according to the embodiment includes the magnetic recording medium, the magnetic head assembly according to the embodiment, and the magnetic memory medium from which information is reproduced using the magnetic head mounted on the magnetic head assembly. The magnetic recording and reproducing apparatus 150 according to the embodiment enables high sensitivity reproduction by using the magnetic head according to the embodiments mentioned above.

FIG. 17A illustrates the configuration of part of the magnetic recording and reproducing apparatus, and is an enlarged perspective view of a head stack assembly 160.

FIG. 17B is a perspective view illustrating the magnetic head assembly (head gimbal assembly; HGA) 158 that is part of the head stack assembly 160.

As shown in FIG. 17A, the head stack assembly 160 includes the bearing portion 157, the magnetic head assembly 158, and a support frame 161. The magnetic head assembly 158 extends from the bearing portion 157. The support frame 161 extends from the bearing portion 157 in the opposite direction to the magnetic head assembly 158. The support frame 161 supports the coil 162 of the voice coil motor.

As shown in FIG. 17B, the magnetic head assembly 158 includes the actuator arm 155 and the suspension 154. The actuator arm 155 extends from the bearing portion 157. The suspension 154 extends from the actuator arm 155.

The head slider 3 is provided at the tip of the suspension 154. The magnetic head 110 is mounted in the head slider 3.

That is, the magnetic head assembly 158 according to the embodiment includes the magnetic head 110 according to the embodiment, the head slider 3 mounted with the magnetic head 110, the suspension 154 mounted with the magnetic head 110 at one end, and the actuator arm 155 connected to the other end of the suspension 154.

The suspension 154 includes lead wires (not shown) for writing and reading signals, for a heater for adjusting the levitating height, and for other purposes. These lead wires and the respective electrodes of the magnetic head incorporated in the head slider 3 are electrically connected.

### FOURTH EMBODIMENT

A fourth embodiment relates to a method for manufacturing a magneto-resistance effect element. In the embodiment, for example, the processing described in regard to FIG. 5A to FIG. 5E is performed.

In the manufacturing method according to the embodiment, the first magnetic film 21f is formed on a first shield (the first shield 11), the intermediate film 25f is formed on the first magnetic film 21f, the second magnetic film 22f is formed on the intermediate film 25f, and a shield film (the third shield film 13f) is formed on the second magnetic film 22. That is, a stacking process is performed.

Then, the first magnetic film 21f, the intermediate film 25f, the second magnetic film 22f, and the third shield film 13f are patterned to form the first magnetic layer 21, the intermediate layer 25, the second magnetic layer 22, and a second shield (the third shield 13).

Then, on the second shield (the third shield 13), a third shield (the second shield 12) of which the length in the first direction crossing the stacking direction from the first shield 11 toward the second shield (the third shield 13) is longer than the length in the first direction of the second shield (the third shield 13) is formed in contact with the second shield (the third shield 13). That is, the third shield (the second shield 12) is formed directly on the second shield (the third shield 13).

The stacking process mentioned above includes forming a second shield film (the fourth shield film 14f) on and in contact with the first shield 11. That is, the second shield film (the fourth shield film 14f) is formed directly on the first shield 11. The stacking process mentioned above further includes forming the first magnetic film 11f on the second shield film (the fourth shield film 14).

The patterning process mentioned above includes patterning at least part of the second shield film (the fourth shield film 14f) to form the fourth shield 14. The patterning process mentioned above includes forming the length in the first direction of the fourth shield 14 smaller than the length in the first direction of the first shield (the first shield 11).

The embodiment can provide a method for manufacturing a magneto-resistance effect element that can be miniaturized.

The embodiment can provide a magneto-resistance effect element, a magnetic head, a magnetic head assembly, and a magnetic recording and reproducing apparatus that can be miniaturized and a method for manufacturing a magneto-resistance effect element that can be miniaturized.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

In the specification of this application, the state of being “provided on” includes not only the state of being provided in direct contact but also the state of being provided via another component. The state of being “stacked” includes not only the state of being stacked in contact with each other but also the state of being stacked via another component. The state of being “opposed” includes not only the state of facing directly but also the state of facing via another component.

Hereinabove, embodiments of the invention are described with reference to specific examples. However, the invention is not limited to these specific examples. For example, one skilled in the art may appropriately select specific configurations of components of magneto-resistance effect elements such as shields, magnetic layers, nonmagnetic layers, intermediate layers, and electrode units from known art and similarly practice the invention. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magneto-resistance effect elements, magnetic heads, magnetic head assemblies, magnetic recording and reproducing apparatuses, and methods for manufacturing the magneto-resistance effect elements practicable by an appropriate design modification by one skilled in the art based on the magneto-resistance effect elements, magnetic heads, magnetic head assemblies, magnetic recording and reproducing apparatuses, and methods for manufacturing the magneto-resistance effect elements described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magneto-resistance effect element comprising:
a first shield;
a second shield;
a third shield provided between the first shield and the second shield, being in contact with the second shield, and having a length along a first direction crossing a stacking direction from the first shield toward the second shield shorter than a length along the first direction of the second shield,
a first magnetic layer provided between the first shield and the third shield;
a second magnetic layer provided between the first magnetic layer and the third shield and exchange-coupled to the third shield; and
an intermediate layer provided between the first magnetic layer and the second magnetic layer.

2. The element according to claim 1, wherein the third shield is formed in one body with the second shield.

3. The element according to claim 1, wherein the third shield includes a same material as a material included in the second shield.

4. The element according to claim 1, wherein an area of a surface opposed to the second magnetic layer of the third shield is not less than 25 square nanometers and not more than 900 square nanometers.

5. The element according to claim 1, further comprising a third magnetic layer provided between the third shield and the second magnetic layer.

6. The element according to claim 1, wherein a length of the third shield along a direction crossing the stacking direction and the first direction is shorter than a length of the second shield along the crossing direction.

7. The element according to claim 1, further comprising a fourth shield provided between the first shield and the first magnetic layer, being in contact with the first shield, and exchange-coupled to the first magnetic layer,
the fourth shield having at least one of
a length along the first direction shorter than a length along the first direction of the first shield and
a length along a second direction crossing the stacking direction and the first direction shorter than a length along the second direction of the first shield.

8. The element according to claim 7, wherein the fourth shield is formed in one body with the first shield.

9. The element according to claim 7, wherein the fourth shield includes a same material as a material included in the first shield.

10. The element according to claim 7, wherein an area of a surface opposed to the first magnetic layer of the fourth shield is not less than 25 square nanometers and not more than 900 square nanometers.

11. The element according to claim 1, further comprising a fourth magnetic layer provided between the first shield and the first magnetic layer.

12. A magneto-resistance effect element comprising:
a first shield;
a second shield;
a nonmagnetic layer provided between the first shield and the second shield;
a first magnetic layer provided between the nonmagnetic layer and the second shield;
a third shield provided between the first magnetic layer and the second shield, being in contact with the second shield, and having a length along a first direction crossing a stacking direction from the first shield toward the second shield shorter than a length along the first direction of the second shield;
a second magnetic layer provided between the nonmagnetic layer and the second shield and being apart from the first magnetic layer in a second direction crossing the stacking direction and the first direction;
a first electrode unit provided between the second magnetic layer and the second shield; and
an insulating layer provided between the first electrode unit and the second shield.

13. The element according to claim 12, wherein a magnetization of the second magnetic layer is fixed.

14. The element according to claim 12, wherein an area of a surface opposed to the first magnetic layer of the third shield is not less than 25 square nanometers and not more than 900 square nanometers.

15. The element according to claim 12, further comprising a second electrode unit connected to the nonmagnetic layer.

16. A magnetic head comprising a magneto-resistance effect element,
the element including:
a first shield;
a second shield;
a third shield provided between the first shield and the second shield, being in contact with the second shield, and having a length along a first direction crossing a stacking direction from the first shield toward the second shield shorter than a length along the first direction of the second shield;
a first magnetic layer provided between the first shield and the third shield;
a second magnetic layer provided between the first magnetic layer and the third shield and exchange-coupled to the third shield; and
an intermediate layer provided between the first magnetic layer and the second magnetic layer.

17. A magnetic head assembly comprising:
a magnetic head;
a suspension mounted with the magnetic head at one end; and
an actuator arm connected to another end of the suspension
the head including a magneto-resistance effect element,
the element including:
a first shield;
a second shield;
a third shield provided between the first shield and the second shield, being in contact with the second shield, and having a length along a first direction crossing a stacking direction from the first shield toward the second shield shorter than a length along the first direction of the second shield;
a first magnetic layer provided between the first shield and the third shield;
a second magnetic layer provided between the first magnetic layer and the third shield and exchange-coupled to the third shield; and
an intermediate layer provided between the first magnetic layer and the second magnetic layer.

18. A magnetic recording and reproducing apparatus comprising:
a magnetic head assembly; and
a magnetic recording medium, information being reproduced from the magnetic recording medium using the magnetic head mounted on the magnetic head assembly
the magnetic head assembly including:
a magnetic head;
a suspension mounted with the magnetic head at one end; and
an actuator arm connected to another end of the suspension
the head including a magneto-resistance effect element,
the element including:
a first shield;
a second shield;
a third shield provided between the first shield and the second shield, being in contact with the second shield, and having a length along a first direction crossing a stacking direction from the first shield toward the second shield shorter than a length along the first direction of the second shield;
a first magnetic layer provided between the first shield and the third shield;
a second magnetic layer provided between the first magnetic layer and the third shield and exchange-coupled to the third shield; and
an intermediate layer provided between the first magnetic layer and the second magnetic layer.

19. A method for manufacturing a magneto-resistance effect element comprising:
stacking including forming a first magnetic film on a first shield, forming an intermediate film on the first magnetic film, forming a second magnetic film on the intermediate film, and forming a first shield film on the second magnetic film;
patterning including patterning the first magnetic film, the intermediate film, the second magnetic film, and the first shield film to form a first magnetic layer, an intermediate layer, a second magnetic layer, and a second shield; and
forming a third shield directly on the second shield, the third shield having a length in a first direction crossing a stacking direction from the first shield toward the second shield longer than a length in the first direction of the second shield.

20. The method according to claim 19, wherein the stacking includes:
forming a second shield film directly on the first shield; and
forming the first magnetic film on the second shield film, and
the patterning includes patterning at least a part of the second shield film to form a fourth shield and the patterning includes forming a fourth shield having a length in the first direction smaller than a length in the first direction of the first shield.
